(19) United States
(12) Patent Application Publication
(10) Pub. No.: US 2026/0197167 A1
(43) Pub. Date: Jul. 9, 2026

(54) SECURE END-TO-END SIGNALING FOR AMBIENT POWER (AMP) DEVICES

(71) Applicant: QUALCOMM Incorporated, San Diego, CA (US)

(72) Inventors: Sanket Sanjay KALAMKAR, San Diego, CA (US); George CHERIAN, San Diego, CA (US); Alfred ASTERJADHI, San Diego, CA (US); Sai Yiu Duncan HO, San Diego, CA (US); Abhishek Pramod PATIL, San Diego, CA (US)

(21) Appl. No.: 19/012,801

(22) Filed: Jan. 7, 2025

(51) Int. Cl. H04L 9/08; H04L 9/14; H04L 9/32; H04W 88/08

(52) U.S. Cl. CPC H04L 9/0869; H04L 9/14; H04L 9/32; H04W 88/08

(57) ABSTRACT

This disclosure provides methods, components, devices and systems for secure end-to-end signaling for ambient power (AMP) devices. Some aspects more specifically relate to signaling and techniques that provide security for communications with AMP wireless devices, in which an AMP wireless device may be configured with a pairwise master key (PMK). An access point (AP) may transmit an energizing signal to an AMP wireless device, which may supply power to one or more components of the AMP wireless device. The AP also may transmit a key request to the AMP wireless device that may include a first random number. The AMP wireless device may generate a pairwise transient key (PTK) based on the PMK and a second random number generated at the AMP wireless device. The AMP wireless device may transmit a response message to the AP that includes the second random number, and that is secured using the PTK.

### TECHNICAL FIELD

This disclosure relates generally to wireless communication and, more specifically, to secure end-to-end signaling for ambient power devices.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at an ambient power (AMP) wireless device. The method may include receiving an energizing signal associated with supplying power to one or more components of the AMP wireless device, receiving a key generation request that includes a first random number associated with generating a security key, transmitting, in accordance with the power supplied to the one or more components of the AMP wireless device, a response message indicating a second random number and an integrity check, where the integrity check is associated with the security key, the second random number, and a master key, and receiving at least a first operational message associated with a first data communication from the AMP wireless device, where the first operational message, a payload associated with the first operational message, or both, are secured using the security key.

Another innovative aspect of the subject matter described in this disclosure can be implemented in an AMP wireless device. The AMP wireless device may include a processing system that includes processor circuitry and memory circuitry that stores code. The processing system may be configured to cause the AMP wireless device to receive an energizing signal associated with supplying power to one or more components of the AMP wireless device, receive a key generation request that includes a first random number associated with generating a security key, transmit, in accordance with the power supplied to the one or more components of the AMP wireless device, a response message indicating a second random number and an integrity check, where the integrity check is associated with the security key, the second random number, and a master key, and receive at least a first operational message associated with a first data communication from the AMP wireless device, where the first operational message, a payload associated with the first operational message, or both, are secured using the security key.

Another innovative aspect of the subject matter described in this disclosure can be implemented in an AMP wireless device. The AMP wireless device may include means for receiving an energizing signal associated with supplying power to one or more components of the AMP wireless device, means for receiving a key generation request that includes a first random number associated with generating a security key, means for transmitting, in accordance with the power supplied to the one or more components of the AMP wireless device, a response message indicating a second random number and an integrity check, where the integrity check is associated with the security key, the second random number, and a master key, and means for receiving at least a first operational message associated with a first data communication from the AMP wireless device, where the first operational message, a payload associated with the first operational message, or both, are secured using the security key.

Another innovative aspect of the subject matter described in this disclosure can be implemented in a non-transitory computer-readable medium storing code for wireless communication by an AMP wireless device. The code may include instructions executable by a processing system to receive an energizing signal associated with supplying power to one or more components of the AMP wireless device, receive a key generation request that includes a first random number associated with generating a security key, transmit, in accordance with the power supplied to the one or more components of the AMP wireless device, a response message indicating a second random number and an integrity check, where the integrity check is associated with the security key, the second random number, and a master key, and receive at least a first operational message associated with a first data communication from the AMP wireless device, where the first operational message, a payload associated with the first operational message, or both, are secured using the security key.

In some implementations of the methods, AMP wireless devices, and non-transitory computer-readable medium described herein, at least an information portion the first operational message may be encrypted using the PTK, and the method, AMP wireless devices, and non-transitory computer-readable medium may include further operations, features, means, or instructions for decrypting the first operational message using the PTK and transmitting an operational response message in accordance with an indication in the first operational message.

In some implementations of the methods, AMP wireless devices, and non-transitory computer-readable medium described herein, the first operational message may be an operation mode request message and the method, apparatuses, and non-transitory computer-readable medium may include further operations, features, means, or instructions for transmitting, in response to the operation mode request message, an operation mode response message that provides operational details associated with the AMP wireless device.

In some implementations of the methods, AMP wireless devices, and non-transitory computer-readable medium described herein, the key generation request further indicates an operation mode request for operational details associated with the AMP wireless device and the response message indicates the second random number, the integrity check, and an operation mode response that provides the operational details associated with the AMP wireless device.

In some implementations of the methods, AMP wireless devices, and non-transitory computer-readable medium described herein, the first operational message may be a trigger message and the method, apparatuses, and non-transitory computer-readable medium may include further operations, features, means, or instructions for transmitting a trigger response with a data payload associated with the trigger message, where the trigger response may be secured using the security key.

In some implementations of the methods, AMP wireless devices, and non-transitory computer-readable medium described herein, the first operational message may be a trigger message and the method, apparatuses, and non-transitory computer-readable medium may include further operations, features, means, or instructions for receiving a set of multiple trigger messages and transmitting a trigger response message to one or more randomly selected trigger messages of the set of multiple trigger messages.

Another innovative aspect of the subject matter described in this disclosure can be implemented in a method for wireless communications by an AP. The method may include transmitting an energizing signal to an AMP wireless device for supplying power to one or more components of the AMP wireless device, transmitting a key generation request to the AMP wireless device that includes a first random number, and receiving, from the AMP wireless device, a response message indicating a second random number and an integrity check, where the second random number is different from the first random number, and the second random number, the integrity check, or both are secured in accordance with a security key that is associated with the first random number, the second random number, and a master security key.

Another innovative aspect of the subject matter described in this disclosure can be implemented in an AP. The AP may include a processing system that includes processor circuitry and memory circuitry that stores code. The processing system may be configured to cause the AP to transmit an energizing signal to an AMP wireless device for supplying power to one or more components of the AMP wireless device, transmit a key generation request to the AMP wireless device that includes a first random number, and receive, from the AMP wireless device, a response message indicating a second random number and an integrity check, where the second random number is different from the first random number, and the second random number, the integrity check, or both are secured in accordance with a security key that is associated with the first random number, the second random number, and a master security key.

Another innovative aspect of the subject matter described in this disclosure can be implemented in an AP. The AP may include means for transmitting an energizing signal to an AMP wireless device for supplying power to one or more components of the AMP wireless device, means for transmitting a key generation request to the AMP wireless device that includes a first random number, and means for receiving, from the AMP wireless device, a response message indicating a second random number and an integrity check, where the second random number is different from the first random number, and the second random number, the integrity check, or both are secured in accordance with a security key that is associated with the first random number, the second random number, and a master security key.

Another innovative aspect of the subject matter described in this disclosure can be implemented in a non-transitory computer-readable medium storing code for wireless communication by an AP. The code may include instructions executable by a processing system to transmit an energizing signal to an AMP wireless device for supplying power to one or more components of the AMP wireless device, transmit a key generation request to the AMP wireless device that includes a first random number, and receive, from the AMP wireless device, a response message indicating a second random number and an integrity check, where the second random number is different from the first random number, and the second random number, the integrity check, or both are secured in accordance with a security key that is associated with the first random number, the second random number, and a master security key.

Some implementations of the methods, APs, and non-transitory computer-readable medium described herein may further include operations, features, means, or instructions for transmitting, to the AMP wireless device, at least a first operational message associated with a first data communication of the AMP wireless device, where the first operational message, a payload associated with the first operational message, or both, may be secured using the security key.

Some implementations of the methods, APs, and non-transitory computer-readable medium described herein may further include operations, features, means, or instructions for transmitting an operation mode request message to the AMP wireless device, where the operation mode request message, a payload associated with the operation mode request message, or both, may be secured using the security key and receiving, in response to the operation mode request message, an operation mode response message that provides operational details associated with the AMP wireless device, where the operation mode response message, a payload associated with the operation mode response message, or both, may be secured using the security key.

In some implementations of the methods, APs, and non-transitory computer-readable medium described herein, the key generation request further indicates an operation mode request for operational details associated with the AMP wireless device and the response message indicates the second random number, the integrity check, and an operation mode response that provides the operational details associated with the AMP wireless device.

Some implementations of the methods, APs, and non-transitory computer-readable medium described herein may further include operations, features, means, or instructions for transmitting a trigger message to the AMP wireless device, where the trigger message, a payload associated with the trigger message, or both, may be secured using the security key and receiving a trigger response with a data payload associated with the trigger message, where the trigger response, the payload, or both, may be secured using the security key.

Some implementations of the methods, APs, and non-transitory computer-readable medium described herein may further include operations, features, means, or instructions for transmitting a set of multiple operational messages to the AMP wireless device, transmitting, in response to one or more response messages associated with the set of multiple operational message being undetected at the AP, a second operational message to the AMP wireless device that indicates the one or more response messages were not received at the AP, receiving a response from the AMP wireless device that indicates the one or more response messages were transmitted by the AMP wireless device, and modifying one or more of a start time or a duration of an energizing signal associated with one or more operational messages.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows an example of end-to-end ambient power device operation for ambient power devices.

FIGS. 4 through 7 show examples of process flows that support secure end-to-end signaling for ambient power devices.

FIGS. 8A, 8B, 8C, 8D, 8E, 8F and 8G show examples of signaling diagrams that support secure end-to-end signaling for ambient power devices.

FIG. 9 shows a block diagram of an example wireless communication device that supports secure end-to-end signaling for ambient power devices.

FIG. 10 shows a block diagram of an example wireless communication device that supports secure end-to-end signaling for ambient power devices.

FIG. 11 shows a flowchart illustrating an example process performable by or at an ambient power wireless device that supports secure end-to-end signaling for ambient power devices.

FIG. 12 shows a flowchart illustrating an example process performable by or at an access point (AP) that supports secure end-to-end signaling for ambient power devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Some wireless communication networks may support various deployments for ambient power (AMP)-enabled communications (such as AMP deployments). In such deployments, one or more wireless communication devices may lack an internal power source (such as a battery) or may otherwise have relatively limited energy storage or other capabilities. Such devices may perform energy harvesting using one or more energy sources or signals to communicate (such as transmit or receive) data. In some examples, these devices may be relatively low-complexity devices (such as due to an environment in which the device operates, due to a functionality of the device, due to a form factor of the device, due to a relatively reduced cost of the device, or due to a design of the device, among other examples) and may be referred to as AMP wireless devices, energy-harvesting devices, ambient power tags, low-power devices, zero-power devices, ambient power-enabled Internet of Things (IoT) devices, or similar nomenclature.

Deployments including one or more AMP wireless devices may be associated with various configurations for supporting energy harvesting and AMP-enabled communications. For example, one or more devices (such as one or more access points (APs), stations (STAs), relays, readers, or the like) may provide a signal (such as an energizing signal, an energizer signal, or an excitation signal) to an AMP wireless device such that the AMP wireless device harvests the energy from the signal and supplies power to (for example, powers up, or activates) one or more components (such as one or more radio frequency (RF) components, or one or more processing components) of the AMP wireless device for communications. After the components are powered up, data may be communicated between the AMP wireless device and the one or more devices that provided the signal. Additionally, or alternatively, the AMP wireless device may communicate with one or more other devices (such as one or more APs, STAs, relays, readers, or the like) that did not provide the energizing signal. In some examples, one or more additional devices (such as energizers, or energizing devices), which may not communicate control information or data with the AMP wireless device, may supply the energizing signals that are used for energy harvesting at the AMP wireless devices.

In either example scenario, signaling techniques that support efficient and low-power communications across deployment configurations may be desirable. Further, the relatively low complexity of some AMP wireless devices may support a relatively small number of transmissions and receptions within one communications session, and techniques that provide efficient and secure communications may be desirable. Specifically, because some AMP wireless devices may lack persistent memory capabilities (such as due to the absence of a power source for maintaining volatile memory, or due to an absence of, or relatively small amount of, non-volatile memory), it may be desirable to implement efficient techniques to enable security, integrity check, and authentication for respective messages transmitted by the AMP wireless devices (for example, because security, integrity check, and authentication information may not be re-used across communications sessions by a device that lacks power between such sessions).

Various aspects relate generally to ambient power-enabled communications and ambient power deployments. Some aspects more specifically relate to signaling and techniques that provide security for communications with AMP wireless devices. In some examples, to facilitate secure signaling to and from one or more AMP wireless devices, the one or more AMP wireless devices may be configured (such as at the time of manufacture, during an onboarding/setup process, or at some later stage) with a pre-shared key (PSK) that may be used to generate a pairwise master key (PMK). In some examples, to provide secured communications, an AP may transmit an energizing signal to the AMP wireless device, and the AMP wireless device may use energy of the energizing signal to supply power to one or more components of the AMP wireless device (such as transmit and receive RF components, or processing components). Included with the energizing signal, or separately from the energizing signal, the AP may transmit a key request to the AMP wireless device that may include a first random number (such as a first nonce, an ANonce). The AMP wireless device may receive the key request, in accordance with power supplied from the energizing signal, and may generate a pairwise transient key (PTK) based on the PMK, the first random number, a second random number (such as a second nonce, a SNonce) generated at the AMP wireless device, an identifier (such as a medium access control (MAC) address) associated with the AMP wireless device, and an identifier (such as a MAC address) associated with the AP. The AMP wireless device may transmit a response message to the AP that includes the second random number, and that is secured using the PTK, such as with a message integrity check (MIC) that is computed using the PTK. The AP may receive the response message and compute the PTK based on the PMK, the first random number, the second random number provided by the AMP wireless device, the identifier (such as the MAC address) associated with the AMP wireless device, and an identifier (such as a MAC address) associated with the AP. In some examples, the identifiers (such as MAC addresses) used to generate the PTK may be generated randomly. The AP also may verify the MIC to confirm that the response message was transmitted by the AMP wireless device.

In some examples, in accordance with the PTK that is available at both the AMP wireless device and the AP, one or more operational messages and responses may be communicated (such as transmitted or received) between the AMP wireless device and the AP that are secured using encryption, MICs, or both. For example, the AP may transmit an operation mode request that is encrypted based on the PTK, includes a MIC based on the PTK, or both. The AMP wireless device may receive the operation mode request, and decrypt, perform a MIC, or both, and transmit an operation mode response message in accordance with a successful decryption, MIC, or both. In some examples, the operation mode response message may be secured using encryption, a MIC, or both, based on the PTK, which may be integrity checked, decrypted, or both, at the AP. In some other examples, the one or more operational messages may include a trigger frame and an associated trigger response message, which may be secured with encryption, a MIC, or both, based on the PTK. Additionally, or alternatively, the key request message also may include an operational message, and the associated response message from the AMP wireless device may include the second random number and a response to the operational message, which may be secured using a MIC. In some examples, a portion of an operational message may be encrypted. For example, the payload or data carried in an operational message may be encrypted, and other portions of the operation message may be unencrypted. Further, in some examples, the AP may transmit a key confirmation message to the AMP wireless device that confirms the AP has successfully derived the PTK.

Additionally, the techniques described herein may address potential attack scenarios, such as an attacker device that may transmit operational messages to the AMP wireless device without associated subsequent communications, or an attacker device that transmits an operational message to the AMP wireless device subsequent to the energizing signal but prior to transmission of an operational message from the AP. In some examples, the AMP wireless device may discontinue transmitting response messages when associated subsequent communications are not received. Additionally, or alternatively, the AMP wireless device may respond selectively to randomly selected messages that are received at the AMP wireless device. Additionally, or alternatively, the AP may randomize a pattern of energizing signals (such as by altering a start time or duration of energizing signals), or may request feedback from the AMP wireless device related to unreceived responses from the AMP wireless device associated with one or more prior request messages transmitted to the AMP wireless device.

Particular aspects of the subject matter described in this disclosure can be implemented to realize one or more of the following potential advantages. In some examples, by implementing security for a response message from the AMP wireless device (for example, a key response message or an operational response message), the described techniques can increase the security of data within a wireless communication network, particularly for devices that are unable to store authentication/security information between communication sessions. For example, in accordance with the described techniques, each message sent by an AMP wireless device may be secured by a transient key based on an PMK configured for the AMP wireless device, such as through encryption that may prevent other devices from obtaining information that was transferred, performing integrity checks that may confirm that a message originated at the associated AP or AMP wireless device, or both. As a result, only another device that is in possession of the PMK may have enough information to decrypt the message, authenticate that the response message is from the associated AP or AMP wireless device, or both. Likewise, another device may be unable to impersonate the AMP wireless device (for example, send transmissions that may otherwise appear to be from the AMP wireless device, which may be malicious in nature), because a transmission from the would-be impersonating device may not be secured using the same techniques described herein (namely, generating a security key using the PMK, random numbers, and identifiers/addresses).

Additionally, through establishment and use of the PTK in a response message from the AMP wireless device, an efficient key generation process is implemented that avoids multiple exchanges between devices to establish a key, which may allow the AMP wireless device to complete a communication session with a relatively limited amount of energy and without storing the PTK in persistent memory. Further, potential replay attacks or denial-of-service attacks may be mitigated through discontinuation of response message transmissions by the AMP wireless device or through response messages only for randomly selected request messages.

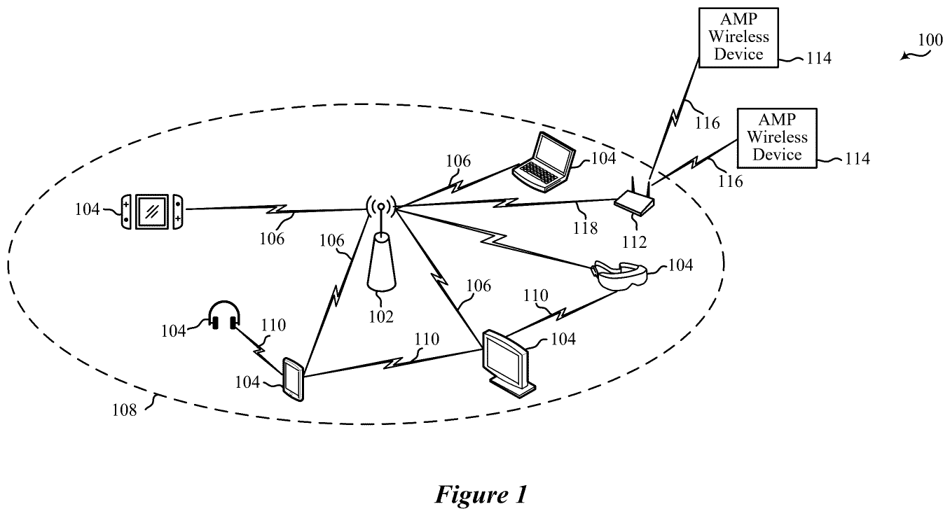

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104.

While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions.

Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

According to some examples, the wireless communication network 100 can be an example of a mesh network, an IoT network, or a sensor network in accordance with one or more of the IEEE 802.11 family of wireless communication protocol standards. The wireless communication network 100 may include AMP wireless devices 114, which in some implementations may include tags (such as for tracking or inventory), sensors, and meters, among other examples. In some examples, the AMP wireless devices 114 sense, measure, collect or otherwise obtain and process data and transmit such raw or processed data to an intermediate device 112 (such as an AMP AP that provides an energizing signal to the AMP wireless devices 114) for subsequent processing or distribution. Additionally, or alternatively, the intermediate device 112 may transmit control information, digital content (for example, audio or video data), configuration information or other instructions to the AMP wireless devices 114. The intermediate device 112 and the AMP wireless devices 114 can communicate with one another via wireless communication links 116. In some examples, the wireless communication links 116 include ultra-wideband (UWB), Bluetooth links, other WPAN (including extended PAN (XPAN)) links, or other short-range communication links.

In some examples, the intermediate device 112 also may be configured for wireless communication with other networks such as with a WLAN or a wireless (for example, cellular) wide area network (WWAN), which may, in turn, provide access to external networks including the Internet. For example, the intermediate device 112 may associate and communicate, over a Wi-Fi link 118, with AP 102. In some examples, the intermediate device 112 may be an example of a network gateway, for example, an IoT gateway. In such a manner, the intermediate device 112 may serve as an edge network bridge providing a Wi-Fi core backhaul for the AMP wireless devices 114. In some examples, the intermediate device 112 can analyze, preprocess and aggregate data received from the AMP wireless devices 114 locally at the edge before transmitting it to other devices or external networks via the Wi-Fi link 118. The intermediate device 112 also can provide additional security for the AMP wireless devices 114 and associated data.

In some examples, the one or more AMP wireless devices 114 may not have an internal battery or may have a relatively limited battery supply or other source of power. As such, these devices may be relatively lower-complexity devices associated with relatively reduced power consumption for wireless communications, for example, via unlicensed (for example, shared) RF spectrum bands. As an example, low cost and low complexity devices may obtain cost savings through reduction of components (such as a battery). In another example, one or more environmental conditions (such as extreme environmental conditions, such as relatively high pressure, extremely high or low temperature, or humid environments, to name a few) may make the inclusion of a battery in a wireless communication device unfeasible. In a further example, various use cases may call for a relatively low-maintenance (or maintenance-free) wireless communication device and, as such, these wireless communication devices may not include a battery so as to avoid regular battery replacement or other maintenance. Additionally, or alternatively, a form factor or other features (such as a device having relatively small dimensions (such as a thickness of 1 millimeter (mm) and area of several square centimeters), a low-cost device, a device associated with an extended life cycle, or the like) may result in the exclusion of a battery or other power source from the wireless communication device. In some cases, these devices may be relatively low-cost devices (such as a tag used for tracking and inventory). Such devices may have a variety of example use cases, including home monitoring (such as monitoring temperature, humidity, or gas leakage), home security (such as detecting intruders approaching a residence), asset management (such as asset tracking, or inventory), industrial or scientific applications (such as industrial wireless sensor networks, product line monitoring, or environment monitoring), to name a few. In some cases, these devices may be referred to as ambient power wireless devices, energy-harvesting devices, ambient power tags, low-power devices, zero-power devices, ambient power-enabled IoT devices, AMP devices, or the like.

These devices having limited (or no) battery or other power source may accordingly be associated with relatively reduced power consumption (for example, ultra-low power consumption, less than 1 milliwatt (mW) power consumption, less than 100 microwatts (μW) power consumption), relatively low complexity (for example, having a relatively simplified RF and baseband architecture, limited memory, or the like), and relatively reduced performance (for example, utilizing relatively simplified waveform/modulation/coding schemes, relatively simplified protocol designs to support ultra-low power operation, or the like). As a result, the devices may use other means to power one or more RF components or integrated circuits (ICs) for wireless communications. For example, an AMP wireless device 114 may be powered via techniques such as energy harvesting from radio waves or other power sources. Such energy harvesting may utilize various sources of energy including electromagnetic energy sources, photovoltaic energy sources, thermal energy sources, vibrational energy sources, or a combination of these sources, among other examples. In some implementations, ambient energy from one or more RF spectrum bands (for example, a 2.4 Gigahertz (GHz) band or a sub-1 GHz band, among others) may be used by AMP wireless devices 114 to supply power to one or more RF components that are configured for wireless communications with one or more other devices (such as intermediate device 112, an AP 102, a STA 104, among other examples, each of which may be referred to as a reader). The AMP wireless devices 114 may include one or more RF components associated with energy harvesting (for example, for receiving the signal(s) used to supply power) in addition to a set of RF components (for example, a main radio) used for the wireless communications. In other cases, the set of RF components may be used for both energy harvesting and wireless communications. Additionally, or alternatively, the AMP wireless devices 114 may include other types of components that may harvest energy from other sources, such as photovoltaic or wind components that harvest solar or wind energy, or RF components that harvest energy from RF signals with different frequencies than used for data communication of AMP wireless devices 114 (such as 125 kHz, 134 kHz, or 13.56 MHz frequency signals), among others.

In some examples, the AMP wireless devices 114 may be configured to support backscatter communication techniques. Backscatter communication techniques may involve a single waveform, which may define the structure and shape of information in transmitted signals, where a received signal is reflected (or backscattered) to enable one or more data transmissions. In some examples, backscatter communication techniques may use a continuous wave, which may be a sinusoidal wave that is modulated with an information-bearing signal to convey information. For example, one or more wireless devices (for example, a transmitting device, such as intermediate device 112, an AP 102 or a STA 104, and which may be referred to as a reader or other terminology) may select a waveform to use to modulate the carrier wave.

The continuous wave transmission to an AMP wireless device 114 may enable the AMP wireless device 114 to collect energy from the continuous wave transmission. The collected energy at the AMP wireless device 114 may reach some voltage (for example, a capacitor may be charged up to an IC voltage on voltage level) at which point the AMP wireless device 114 may turn on (for example, power up an IC, activate, or supply power to). In some cases, the continuous wave transmission may be transmitted for some duration to power up the AMP wireless device 114. After the duration, the transmitting device (or another device) may transmit an information signal (for example, including one or more commands) to the AMP wireless device 114, where the information signal also may enable the AMP wireless device 114 to harvest energy and remain active (for example, powered on). The one or more commands may include instructions for the AMP wireless device 114 to transmit some signaling or information requested by the transmitting device. The transmitting device may transmit the continuous wave transmission to maintain the applied power (for example, powered up) state of the AMP wireless device 114 until a response to the one or more commands from the AMP wireless device 114 is received. In some examples, powering up the AMP wireless device 114, maintaining the powered up state of the AMP wireless device 114, and transmitting the power and carrier wave for modulation may use a same waveform. The AMP wireless device 114 may transmit and receive one or more PPDUs, in which all or a portion of some PPDUs may be secured in accordance with various techniques as discussed herein.

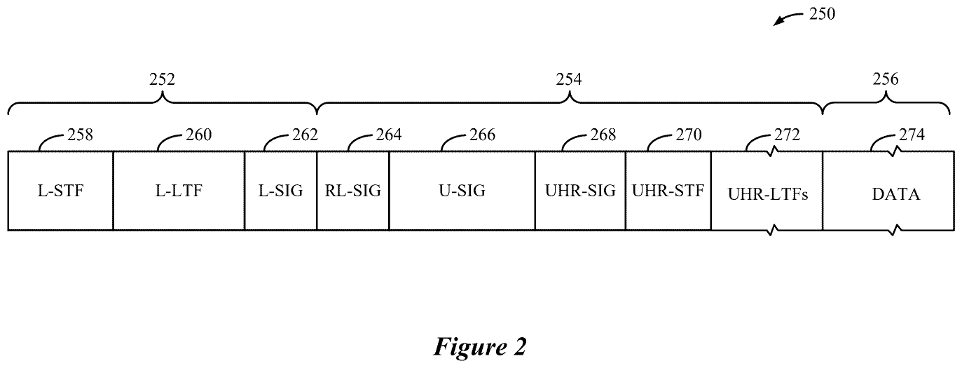

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (for example, STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (for example, a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (for example, a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

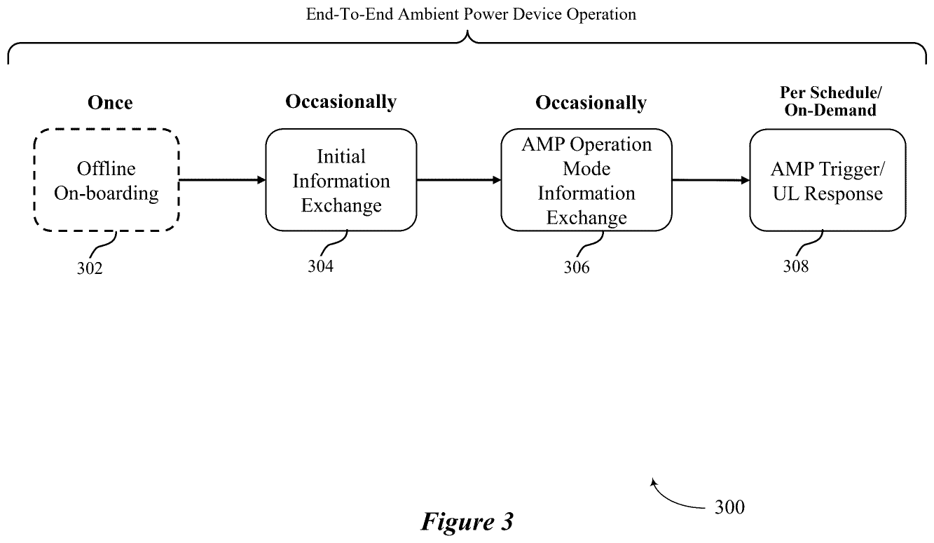

FIG. 3 shows an example of end-to-end ambient power device operation 300 for ambient power devices. For example, the end-to-end ambient power device operation 300 may illustrate wireless communications between a wireless communication device (such as an AMP AP) and an AMP wireless device. The wireless communication device may be an example of the AP 102, the STAs 104, or the intermediate device 112, described with reference to FIG. 1. The AMP wireless device may be an example of the AMP wireless devices 114 described with reference to FIG. 1. Efficient signaling techniques as discussed herein may be implemented in various examples of the end-to-end ambient power device operation 300 may allow for AMP wireless devices to complete communications sessions with a relatively small amount of stored power, while providing security for such communications without storage of temporary keys in persistent memory at the AMP wireless device.

In some examples, offline on-boarding 302 may be performed in which the AMP wireless device may be configured with a pairwise master key (PMK). For example, such a procedure may be performed when the AMP wireless device is associated with an object or item, and a password is programmed at the AMP wireless device, where the password may act as pre-shared key (PSK), and the password is known to the AMP wireless device and an associated AMP AP. The PMK may be generated from the PSK, and thus also may be known at both the AMP wireless device and the AMP AP. In later phases, the PMK may be used to generate transient keys (such as the pairwise transient key (PTK)), that may be used for message integrity check, encryption, or both. In some examples, offline on-boarding 302 may be performed once for the AMP wireless device to establish the PSK and associated PMK.

An initial information exchange 304, or discovery process, may be performed in which an AMP AP and AMP wireless device exchange basic information for the first time after offline on-boarding 302. For example, the AMP AP and AMP wireless device may exchange MAC addresses. In some examples, the exchange may be at least partially performed in an offline manner, such as an AMP AP that may obtain the MAC address of the AMP wireless device from a QR code located in proximity to the AMP wireless device. The AMP AP may use this initial information exchange 304 to determine the presence of one or more active AMP wireless devices. In some examples, the initial information exchange 304 may be performed occasionally, such as when the AMP AP desires to determine the presence of one or more active AMP wireless devices. In some examples, the initial information exchange 304 may be performed through the AMP AP transmitting an energizing signal to the AMP wireless device that initiates wireless exchange of MAC addresses, which may be transmitted in an unsecured manner due to the non-sensitive nature of the MAC addresses.

An AMP operation mode information exchange 306 may be performed after the initial information exchange 304 is completed. In some examples, the AMP AP may request the AMP wireless device operation capabilities and more detailed information. The AMP wireless device may provide capability and schedule-related information to the AMP AP in accordance with the request. For example, the AMP wireless device may provide information related to schedule information (such as a periodicity at which the AMP wireless device is configured to measure a parameter, a power budget of the AMP wireless device, or energy harvesting capabilities of the AMP wireless device). The AMP AP may use this information to determine the transmit and receive parameters (for example, the duration of the energizing signal before sending a control frame to the AMP device, the transmit power of the AMP device based on the capabilities, or the frequency of the transmission of the control frame to the AMP device) to reach the AMP wireless device. In some examples, the AMP operation mode information exchange 306 may be performed occasionally, such as when the AMP AP desires to determine operational modes of one or more AMP wireless devices. In some examples, the AMP operation mode information exchange 306 may be combined with the initial information exchange 304.

An AMP trigger and uplink response 308 may be performed in accordance with the operational mode information of one or more AMP wireless device. In some examples, the AMP AP may transmit a trigger or a control frame (such as a trigger PPDU) that indicates the AMP wireless device is to transmit some information, such as a measured parameter or other information programmed at the AMP wireless device). In some examples, the trigger frame may be transmitted in accordance with the schedule provided with the operational mode information. In some examples, the trigger frame and associated uplink response may be transmitted on-demand in accordance with an event (such as the AMP AP coming in proximity of the AMP wireless device, or an inventory process being initiated at the AMP AP).

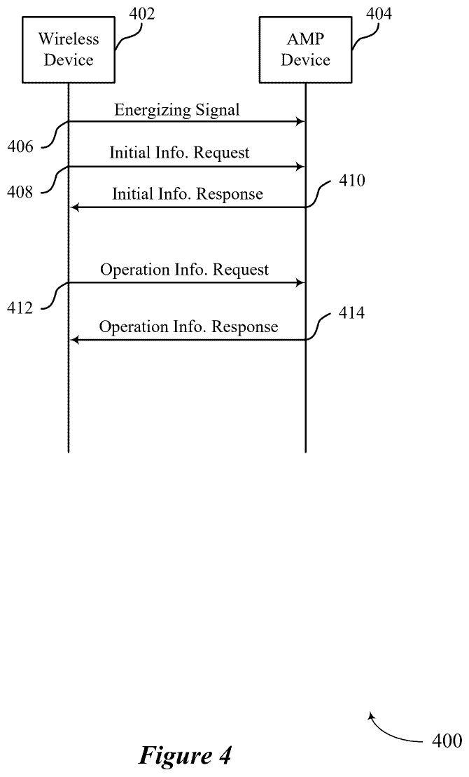

FIG. 4 shows an example of a process flow 400 that supports secure end-to-end signaling for ambient power devices. The process flow 400 may implement aspects of, or be implemented by aspects of, the wireless communication network 100, the PPDU 250, or the end-to-end ambient power device operation 300. For example, the process flow 400 may include a wireless device 402 and an AMP wireless device 404. The wireless device 402 may be an example of an AP (such as an AP 102, an intermediate device 112, or an AMP AP), a network entity, a STA (such as a STA 104), a handheld device, a smart phone, a specialized AMP reader, or another device. In some examples, the AMP wireless device 404 may be an example of a STA (such as STA 104), a handheld device, a smart phone, an AMP device, an AMP tag, or another device. Techniques such as illustrated in FIG. 4 may provide for efficient and secure communications between the wireless device 402 and the AMP wireless device 404.

In the following description of process flow 400, the operations may be performed in a different order than the order shown, or other operations may be added or removed from the process flow 400. For example, some operations also may be left out of process flow 400, may be performed in different orders or at different times, or other operations may be added to process flow 400. Although communications of the process flow 400 are shown occurring between a wireless device 402, and an AMP wireless device 404, the operations of process flow 400 also may be performed by one or more other wireless devices, network devices, or network functions.

In this example, at 406 the wireless device 402 may transmit an energizing signal to the AMP wireless device 404. In some examples, the wireless device 402 may transmit the energizing signal to multiple different AMP wireless devices that are within a proximity of the wireless device. As discussed herein, the energizing signal may provide an energy source for the AMP wireless device 404 to supply power to components of the AMP wireless device 404. In some examples, the energizing signal may be transmitted in a continuous manner that persist for all, or substantially all, of a communications session with the AMP wireless device 404 (such as a continuous carrier signal in backscatter communications, or a continuous energizing signal that spans multiple frame exchanges between the wireless device 402 and the AMP wireless device 404). Additionally, it is noted that various examples described herein (such as the examples of FIGS. 4 through 7) illustrate the energizing signal and various operational signals (such as signals that include initial information request or operation information request) as coming from a same wireless device (such as wireless device 402 of FIG. 4). Such implementations are provided for purposes of discussion and illustration, and various techniques described herein also may be implemented in cases where energizing signals and one or more operational signals may be provided by different devices.

At 408, the wireless device 402 may transmit, and the AMP wireless device 404 may receive, an initial information request. As discussed with reference to FIG. 3, the initial information exchange may provide an exchange of non-sensitive information, such as MAC addresses, and security may not be implemented for such communications. At 410, the AMP wireless device 404 may transmit, and the wireless device 402 may receive, an initial information response. The initial information response may include the MAC address of the AMP wireless device 404 and, as with the initial information request, security may not be implemented for such communications.

At 412, the wireless device 402 may transmit, and the AMP wireless device 404 may receive, an operation information request. As discussed herein, such an operation information request may be performed periodically, and may allow the wireless device 402 to detect the presence of one or more AMP clients, such as AMP wireless device 404, considering factors like energy levels or schedule changes. In some examples, the frequency of such communications may be determined by either the wireless device 402 or the AMP wireless device 404, or it can be negotiated between them. For example, a default periodicity for communications may be set during the offline onboarding of the AMP wireless device 404, and the operation information request may allow the wireless device 402 to determine that a different periodicity is to be used. At 414, the AMP wireless device 404 may transmit, and the wireless device 402 may receive, an operation information response. In some examples, the operation information request may request one or more of schedule information (such as how frequently the wireless device 402 should trigger the AMP wireless device 404), a power budget of the AMP wireless device 404 (such as energy harvesting capabilities of the AMP wireless device 404), or a periodicity of how often the AMP wireless device 404 should be asked for operation information (such as if the schedule changes). The operation information response may include the requested information that the wireless device 402 may use for subsequent communications with the AMP wireless device 404. The information included in the operation information response may be used by an attacker to target the AMP wireless device 404 during scheduling, and in accordance with techniques discussed herein, the operation information response may be secured using, for example, a message integrity check (MIC) that may allow the wireless device 402 to verify that the operation information response was actually transmitted by the AMP wireless device 404.

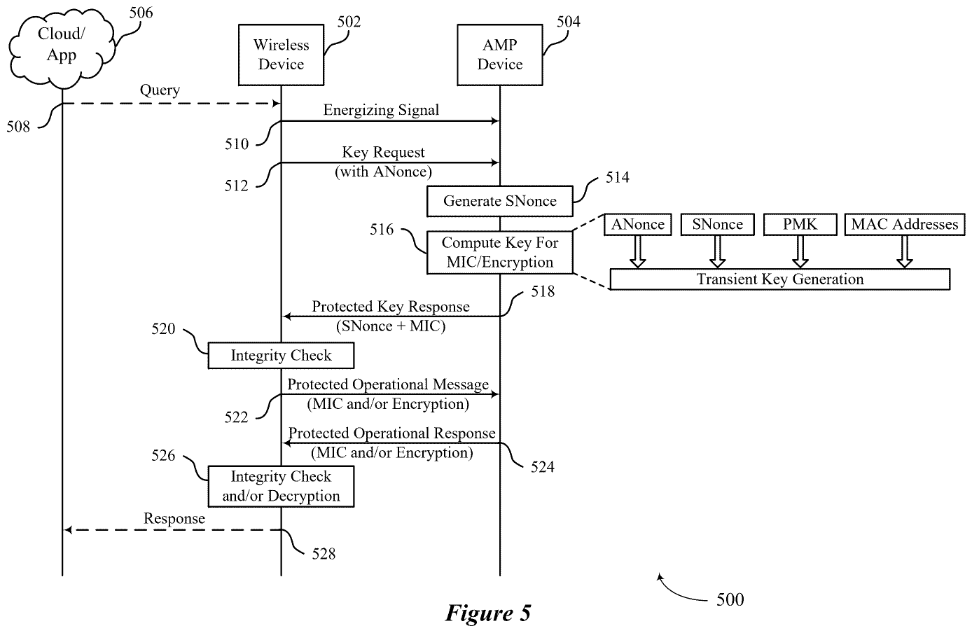

FIG. 5 shows an example of a process flow 500 that supports secure end-to-end signaling for ambient power devices. The process flow 500 may implement aspects of, or be implemented by aspects of, the wireless communication network 100, the PPDU 250, or the end-to-end ambient power device operation 300. For example, the process flow 500 may include a wireless device 502 and an AMP wireless device 504. The wireless device 502 may be an example of an AP (such as an AP 102), a network entity, a STA (such as a STA 104), a handheld device, a smart phone, a specialized AMP reader, an AMP AP, or another device. In some examples, the AMP wireless device 504 may be an example of a STA (such as STA 104), a handheld device, a smart phone, an AMP device, an AMP tag, or another device. In some examples, the process flow 500 may include a server 506, which may be an example of a cloud server, a cloud computing environment, a distributed computing environment, an application server, or one or more other devices or network entities.

In the following description of process flow 500, the operations may be performed in a different order than the order shown, or other operations may be added or removed from the process flow 500. For example, some operations also may be left out of process flow 500, may be performed in different orders or at different times, or other operations may be added to process flow 500. Although communications of the process flow 500 are shown occurring between a wireless device 502, an AMP wireless device 504, and a server 506, the operations of process flow 500 also may be performed by one or more other wireless devices, network devices, or network functions.

As described herein, one or more techniques may be used to provide security of messages transmitted by the AMP wireless device 504, and such techniques may take into account various conditions or parameters associated with the AMP wireless device 504. As an example, the AMP wireless device 504 may not have persistent memory capabilities and the AMP wireless device 504 may include an PMK that is determined from a PSK programmed at the time of on-boarding. The AMP wireless device 504 may have relatively limited or low computational abilities, and therefore security techniques may be associated with relatively low-complexity procedures. Additionally, there may not be a need to secure/protect a query that is sent to the AMP wireless device 504, but the device sending the query may need to be able to validate a response message received from the AMP wireless device 504. For example, any device may be able to query the AMP wireless device 504 (such as to check the price of an item), and the device should be able to validate the response from the AMP wireless device 504.

The process flow 500 may illustrate an example of one or more models used for querying the AMP wireless device 504. For example, a first model may be associated with a cloud-based query, where the wireless device 502 operates in association with the server 506 to obtain information from the AMP wireless device. In this implementation, only the server 506 and the AMP wireless device may be in possession of (for example, store) an PMK used for security key generation. In a second model (for example, a direct query model), queries may be sent by the wireless device 502, and the wireless device 502 may validate the information from the AMP wireless device 504 directly. In this implementation, the wireless device 502 and the AMP wireless device may be in possession of (for example, store) the PMK. In some examples, the process flow 500 may be an example of one or more one-way authentication procedures, for example, where the AMP wireless device 504 may not directly perform authentication for the wireless device 502 (or other devices) prior to communication. For instance, the AMP wireless device 504 may lack or have limited memory capabilities, and it may not be possible for the AMP wireless device to maintain authentication information between sessions or transmissions by the AMP wireless device 504. At 510, one or more energizing signals may be transmitted to the AMP wireless device 504 to enable the AMP wireless device 504 to harvest RF energy and supply power to one or more RF components for each session/transmission. In some examples, the energizing signals may be sent in an on-demand manner (for example, on a per-session basis) to enable communications by the AMP wireless device 504. Additionally, or alternatively, the energizing signals may be transmitted in a continuous manner that persist for all, or substantially all, of a communications session with the AMP wireless device 504 (such as a continuous carrier signal in backscatter communications, or a continuous energizing signal that spans multiple frame exchanges between the wireless device 502 and the AMP wireless device 504).

As an example of the first model (such as the cloud-based query model), at 508 the server 506 may send a query message (such as a query, or a downlink PPDU) to the wireless device 502. The query message may, in some examples, be sent from the server 506 via one or more other devices, such as one or more APs or other devices. In some examples, the query message sent from the server 506 may optionally include a first random number generated by the server 506 or one or more network entities. The first random number may be a random number or a pseudo-random number and may be a number that an authentication protocol attaches to communications. The first random number may introduce randomness, time-stamping, or both, into communications and may be used for security, authentication, or both. In some examples, the first random number may be referred to as a nonce, an authenticator nonce (ANonce), or some similar terminology.

At 512, the wireless device 502 may transmit a key request message (such as a key query, or a downlink PPDU) to the AMP wireless device 504, where the key request message include the first random number (such as the nonce, or the ANonce). The first random number included in the key request message that is transmitted to the AMP wireless device 504 may be the same random number received from the server 506 (such as when the query message from the server 506 includes the first random number). Alternatively, the wireless device 502 may generate the first random number for inclusion in the query message (such as when the query message from the server 506 excludes the first random number). That is, the first random number may be generated (for example, calculated, or computed) locally at the wireless device 502 if the first random number is not provided by the server 506. In an example of the second model (such as the direct-query model), the wireless device 502 may transmit the key request message at 512 to the AMP wireless device 504 without receiving signaling from the server 506 (for example, a presence of the server 506 may be optional).

At 514, after receiving the query message from the wireless device 502 (for example, based on harvesting energy from one or more signals), the AMP wireless device 504 may generate a second random number. The second random number may be a random number or a pseudo-random number. In some examples, the second random number may be referred to as a nonce, a supplicant nonce (SNonce), or some similar terminology. In some examples, the random number may be generated using a time stamp as a seed, where the time stamp may correspond to the reception of the query message at the AMP wireless device 504.

At 516, the AMP wireless device 504 may generate (for example, compute, calculate, or determine) a security key in response to receiving the query message. In some examples, the security key may be referred to as a pairwise transient key (PTK) or some other terminology. The security key may be computed using a set of one or more parameters including, for example, the first random number, the second random number, the PMK, and identifiers. In some examples, the identifiers may be an example of a MAC address associated with the AMP wireless device 504 and a MAC address associated with the wireless device 502, or some other identifiers or addresses. In some examples, the identifiers (such as MAC addresses) used to generate the PTK may be generated randomly. In some cases, the PMK used for the security key generation may be specific to the data being transmitted by the AMP wireless device 504, based on the first random number provided with the key request.

The PMK may be a key that is stored by the AMP wireless device 504 (for example, at initial set up, or via initial configuration). Further, the PMK may be stored or otherwise known by one or more other devices in communication with the AMP wireless device 504, such as the wireless device 502 or the server 506. For instance, under the second model (for example, the direct-query model) signaling received from the server 506 may be optional (for example, the described techniques may be performed without involvement of the server 506), and the wireless device 502 may accordingly be in possession of (for example, store, or retain) the PMK. Additionally, or alternatively, the server 506 may be in possession of the PMK, such as in accordance with the first model (for example, the cloud-based query model).

The AMP wireless device 504 may generate the security key for encrypting subsequent messages, for generating a set of MIC bits that may be used for enabled MIC procedures associated with the transmission of the response message, or both. Because the second random number (and therefore the security key generated using the second random number) may be generated each time a query message is received by the AMP wireless device 504, the security key may be query-specific and may enable enhanced security for transmissions by the AMP wireless device 504. Additionally, because the security key is generated using the PMK that is only known by either the server 506 or the wireless device 502, other devices may not be able to decrypt transmissions from the AMP wireless device 504 that are encrypted based on the security key, or may not be able to generate the MIC bits that are based on the security key. Similarly, another (potentially malicious) device would not be unable to impersonate the AMP wireless device 504 because the other device does not have the PMK. Thus, the described security techniques may enable both authentication and security for messages transmitted by a device that is unable to store authentication information between sessions, such as the AMP wireless device 504.

At 518, the AMP wireless device 504 may transmit, and the wireless device 502 may receive, a key response message (for example, an uplink PPDU). The key response message may be transmitted in response to the key request message, and may include the set of MIC bits for securing the key response message. The key response message may further indicate the second random number generated by the AMP wireless device.

At 520, the wireless device 502 may perform an integrity check on the key response message. The integrity check may include the wireless device 502 generating the PTK in accordance with the first random number, the second random number, the PMK, and the identifiers, and using the PTK to compute the set of MIC bits. The computed set of MIC bits may be compared to the set of MIC bits provided with the key response message to verity that the message was in fact transmitted by the AMP wireless device 504. In some examples, the MIC uses a key confirmation key (KCK) part of the PTK, and for both integrity check and encryption, the temporal key (TK) part of the PTK is used.

At 522, the wireless device 502 may transmit a protected operational message (such as an operation request message or a trigger message) to the AMP wireless device 504, which may be encrypted in accordance with the PTK, have a set of MIC bits computed in accordance with the PTK, or both. At 524 the AMP wireless device 504 may transmit, and the wireless device 502 may receive, a protected operational response message (such as an operation response message or an uplink trigger response message). In some examples, the operational request and response messages may occur shortly after the key request and response, and the wireless device 502 and AMP wireless device 504 can continue using the key from the previous transaction due to the AMP wireless device 504 remaining powered on from the energizing signal (such as from harvesting enough energy to perform these back-to-back transactions). In some examples, a portion of a portion of operational message or operational response message may be encrypted, such as a payload or data carried in a message, and other portions of the operational message or operational response message may be unencrypted.

At 526, the wireless device 502 may perform an integrity check, decryption, or both, on the operational response message. Such procedures may enable the wireless device 502 to verify (for example, validate) that the response message is from the AMP wireless device 504 and not from another (potentially malicious) device. Accordingly, the described security techniques may enable efficient authentication of messages sent from the AMP wireless device 504.

At 528, the wireless device 502 may optionally send the response message to the server 506 (for example, in accordance with the first model, or the cloud-based query model). In such examples, the server 506 may use the PMK and other information (such as the first random number, the second random number included in the response message, the identifier, or any combination thereof) to decrypt the response message or data included in a payload of the response message. Additionally, or alternatively, the server 506 may perform an integrity check for the response message (for example, based on the set of MIC bits). Such procedures may enable the server 506 to verify (for example, validate) that the response message is from the AMP wireless device 504 and not from another (potentially malicious) device.

In some examples, due to one-way integrity check in which the AMP wireless device 504 does not verify the integrity of the messages from the AP, an attacker could repeatedly send an operational message (such as an operation mode request) to the AMP wireless device 504. For example, the attacker might determine the periodicity of the AMP operation mode mechanism and, just before the wireless device 502 is supposed to transmit the operational message, transmit a fake operation mode request. Alternatively, the attacker might randomly transmit operation mode requests to the AMP wireless device 504. Such attacks may significantly impact AMP clients by draining the AMP client energy, causing a denial-of-service attack, or both. In some examples, to mitigate such attacks, if the AMP wireless device 504 is not scheduled after an initial operational message (such as an AMP operation mode request/response) for a threshold quantity of instances (such as if an attacker sends AMP operation mode requests but does not schedule the client), the AMP wireless device 504 may stops responding to requests. In some examples, the threshold quantity of instances after which to stop responding can be decided by the AMP wireless device 504. Additionally, or alternatively, the AMP wireless device 504 may randomly respond to requests, thus providing that some requests are responded to while others are not, and the wireless device 502 is likely to receive a response to one of its requests.

In some further examples, a potential attacker may send a trigger frame just at the end of the energizing signal to trick the AMP wireless device 504 into responding to the fake trigger frame. Such a situation has consequences for both the wireless device 502 and the AMP wireless device 504, such as draining the AMP wireless device 504 energy due to the uplink transmission to the fake trigger frame, potentially leaving insufficient energy when the actual trigger frame is sent by the wireless device 502, and causing the AMP wireless device 504 to miss the triggering event from the wireless device. Further, the wireless device 502 might assume that the duration or power of the energizing signal preceding its trigger frame was insufficient to energize the AMP wireless device 504, leading the wireless device 502 to increase the duration or power of subsequent energizing signals. This may result in unnecessary resource consumption in the energizing process.

In some examples, to mitigate such potential attacks, the AMP wireless device 504 may stop responding to trigger frames from the attacker if it observes certain behaviors or patterns. For example, if the AMP wireless device 504 has memory to retain its negotiations with the wireless device 502 during offline onboarding or capability discovery (such as if the AMP wireless device 504 is an AMP client co-located with a traditional 802.11 client), the AMP wireless device 504 may identify unusual triggering behavior, such as if the wireless device 502 and the AMP wireless device 504 negotiated periodic triggering, but the trigger frame is received at times that do not correspond to the negotiated schedule. In examples where the AMP wireless device 504 has limited memory (such as an AMP-only client), the AMP wireless device 504 may respond selectively (including responding only) to randomly selected trigger frames, creating uncertainty for the attacker and allowing the wireless device 502 to receive some responses. In some examples, if the wireless device 502 does not detect a response to its trigger frames (such as for a certain number of times), the wireless device 502 may alter or randomize the pattern of subsequent energizing signals, including the start time, duration, or both, until the AMP wireless device 504 responds. This may prevent an attacker from sending a trigger frame at the end of the energizing signal, as they would be unable to predict its end. Additionally, or alternatively, if the AMP wireless device 504 does not respond to one or more of the wireless device 502 trigger frames, the wireless device 502 may request feedback from the AMP wireless device 504 in subsequent trigger frames to understand why the AMP wireless device 504 could not respond previously. Such a feedback request may be made in the event the AMP wireless device 504 has sufficient persistent memory to provide such a feedback based on its experience. The wireless device 502 may use this feedback to detect the presence of an attacker and take appropriate action. For example, if the AMP wireless device 504 indicates it had responded to previous trigger frames that were not received at the wireless device 502, the wireless device 502 may infer an attack. Conversely, if the AMP wireless device 504 indicates it could not respond to the trigger frames in question, the wireless device 502 may assume the issue was not related to an attack and may, for example, adjust a power or duration of the energizing signal.

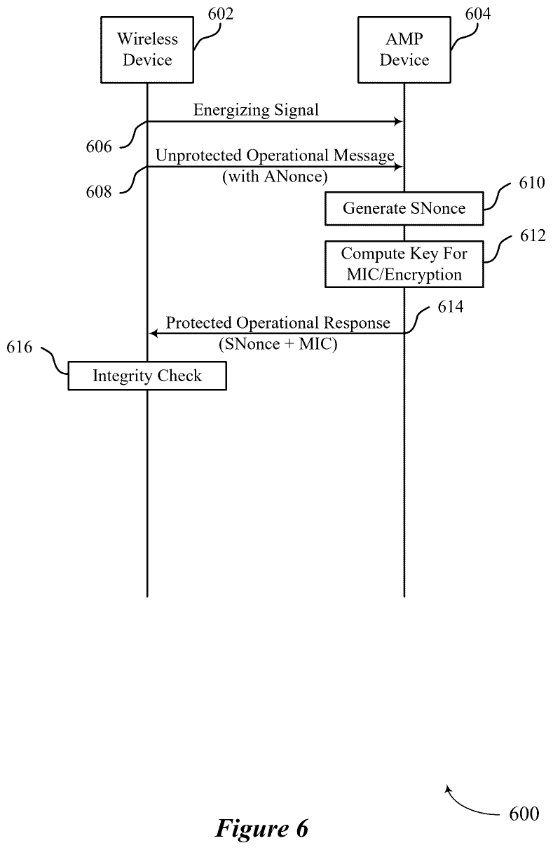

FIG. 6 shows another example of a process flow 600 that supports secure end-to-end signaling for ambient power devices. The process flow 600 may implement aspects of, or be implemented by aspects of, the wireless communication network 100, the PPDU 250, or the end-to-end ambient power device operation 300. For example, the process flow 600 may include a wireless device 602 and an AMP wireless device 604. The wireless device 602 may be an example of an AP (such as an AP 102), a network entity, a STA (such as a STA 104), a handheld device, a smart phone, a specialized AMP reader, an AMP AP, or another device. In some examples, the AMP wireless device 604 may be an example of a STA (such as STA 104), a handheld device, a smart phone, an AMP device, an AMP tag, or another device.

In the following description of process flow 600, the operations may be performed in a different order than the order shown, or other operations may be added or removed from the process flow 600. For example, some operations also may be left out of process flow 600, may be performed in different orders or at different times, or other operations may be added to process flow 600. Although communications of the process flow 600 are shown occurring between a wireless device 602 and an AMP wireless device 604 the operations of process flow 600 also may be performed by one or more other wireless devices, network devices, or network functions.

At 606, one or more energizing signals may be transmitted to the AMP wireless device 604 to enable the AMP wireless device 604 to harvest RF energy and supply power to one or more RF components for each session/transmission. In some examples, the energizing signals may be sent in an on-demand manner (for example, on a per-session basis) to enable communications by the AMP wireless device 604. Additionally, or alternatively, the energizing signals may be transmitted in a continuous manner that persist for all, or substantially all, of a communications session with the AMP wireless device 604 (such as a continuous carrier signal in backscatter communications, or a continuous energizing signal that spans multiple frame exchanges between the wireless device 602 and the AMP wireless device 604).

In some examples, the key request message as discussed with reference to FIG. 5 also may include an operational message such as an operation request message or a trigger message. For example, at 608, the wireless device 602 may transmit an operational message that combines a key request and operational request (such as an operation mode request or a trigger request) to the AMP wireless device 604. The operational message from the wireless device 602 may include the first random number (such as the nonce, or the ANonce) and the operational request.

At 610, after receiving the operational message from the wireless device 602 (for example, based on harvesting energy from one or more signals), the AMP wireless device 604 may generate a second random number (such as a SNonce), in accordance with techniques discussed herein. At 612, the AMP wireless device 604 may generate (for example, compute, calculate, or determine) a security key in response to receiving the operational message. For example, the AMP wireless device 604 may generate a PTK in accordance with techniques discussed herein, using the first random number, the second random number, the PMK, and identifiers (such as a MAC address associated with the AMP wireless device 504, a MAC address associated with the wireless device 602, or some other identifiers or addresses).

At 614, the AMP wireless device 604 may transmit, and the wireless device 602 may receive, a protected operational response to the operational message. In some examples, the operational response may include the second random number (such as the SNonce) generated at the AMP wireless device 604 and a set of MIC bits that are computed based on the PTK, in accordance with techniques discussed herein.

At 616, the wireless device 602 may perform an integrity check on the received response to verify that it was provided by the AMP wireless device 604. In some examples, merging of the key request and response messages with corresponding operational request and response messages may be used when the operational message and response do not contain sensitive information (such as non-sensitive temperature data or a price that is reported by the AMP wireless device 604). Such merging of messages may further reduce the quantity of exchanges between the wireless device 602 and the AMP wireless device 604, which might be helpful for the AMP wireless device 604 given its limited capabilities.

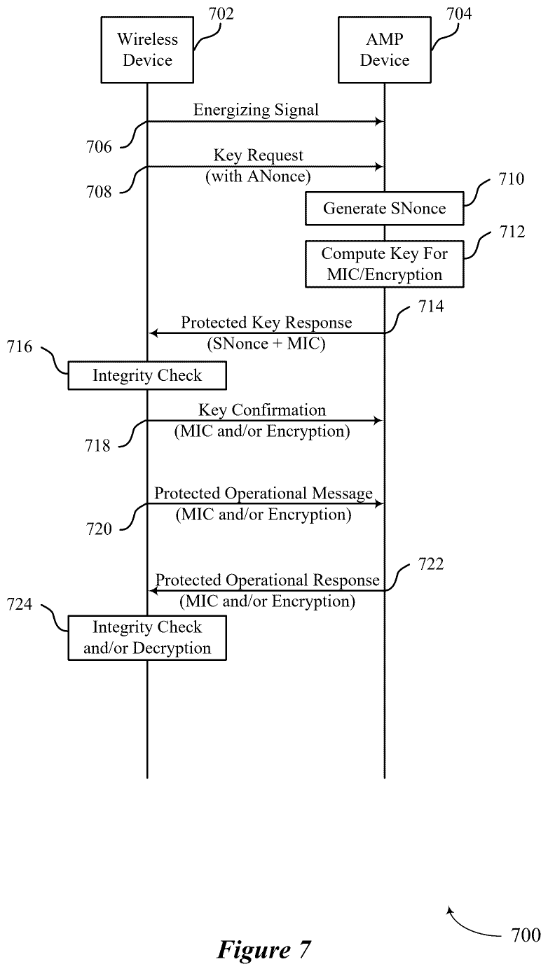

FIG. 7 shows another example of a process flow 700 that supports secure end-to-end signaling for ambient power devices. The process flow 700 may implement aspects of, or be implemented by aspects of, the wireless communication network 100, the PPDU 250, or the end-to-end ambient power device operation 300. For example, the process flow 700 may include a wireless device 702 and an AMP wireless device 704. The wireless device 702 may be an example of an AP (such as an AP 102), a network entity, a STA (such as a STA 104), a handheld device, a smart phone, a specialized AMP reader, an AMP AP, or another device. In some examples, the AMP wireless device 704 may be an example of a STA (such as STA 104), a handheld device, a smart phone, an AMP device, an AMP tag, or another device.

In the following description of process flow 700, the operations may be performed in a different order than the order shown, or other operations may be added or removed from the process flow 700. For example, some operations also may be left out of process flow 700, may be performed in different orders or at different times, or other operations may be added to process flow 700. Although communications of the process flow 700 are shown occurring between a wireless device 702 and an AMP wireless device 704, the operations of process flow 700 also may be performed by one or more other wireless devices, network devices, or network functions.

At 706, one or more energizing signals may be transmitted to the AMP wireless device 704 to enable the AMP wireless device 704 to harvest RF energy and supply power to one or more RF components for each session/transmission. In some examples, the energizing signals may be transmitted in a continuous manner that persist for all, or substantially all, of a communications session with the AMP wireless device 704 (such as a continuous carrier signal in backscatter communications, or a continuous energizing signal that spans multiple frame exchanges between the wireless device 702 and the AMP wireless device 704). At 708, the wireless device 702 may transmit a key request message (such as a key query, or a downlink PPDU) to the AMP wireless device 704, where the key request message include the first random number (such as the nonce, or the ANonce), similarly as discussed with reference to FIGS. 5 and 6.

At 710, after receiving the query message from the wireless device 702 (for example, based on harvesting energy from one or more signals), the AMP wireless device 704 may generate a second random number (such as a SNonce), in accordance with techniques as discussed herein. At 712, the AMP wireless device 704 may generate (for example, compute, calculate, or determine) a security key (such as a PTK) in response to receiving the query message. The security key may be computed using a set of one or more parameters including, for example, the first random number, the second random number, the PMK, and identifiers, in accordance with techniques as discussed herein.

At 714, the AMP wireless device 704 may transmit, and the wireless device 702 may receive, a key response message (for example, an uplink PPDU). The key response message may be transmitted in response to the key request message, and may include a set of MIC bits for securing the key response message, where the MIC bits are computed in accordance with a PTK as discussed herein. The key response message may further indicate the second random number generated by the AMP wireless device.

At 716, the wireless device 702 may perform an integrity check on the key response message. The integrity check may include the wireless device 702 generating the PTK in accordance with the first random number, the second random number, the PMK, and the identifiers, and using the PTK to compute the set of MIC bits. The computed set of MIC bits may be compared to the set of MIC bits provided with the key response message to verity that the message was in fact transmitted by the AMP wireless device 704.

At 718, if the MIC passes, the wireless device 702 may transmit key confirmation message to the AMP wireless device 704. The key confirmation message may confirm to the AMP wireless device 704 that the wireless device 702 has successfully derived the same transient key as that for the AMP wireless device 704, and confirms that both the wireless device 702 and the AMP wireless device 704 are synchronized with the same session keys. Further, the key confirmation message also may provide an encrypted group temporal key (GTK) for multicast and broadcast traffic encryption. The GTK can be used by the AMP wireless device 704 with limited non-volatile memory if it can receive multicast or broadcast traffic from the wireless device 702 before the AMP wireless device 704 loses the power and the GTK.

At 720, the wireless device 702 may transmit a protected operational message (such as an operation request message or a trigger message) to the AMP wireless device 704, which may be encrypted in accordance with the PTK, have a set of MIC bits computed in accordance with the PTK, or both. At 722 the AMP wireless device 704 may transmit, and the wireless device 702 may receive, a protected operational response message (such as an operation response message or an uplink trigger response message). In some examples, the operational request and response messages may occur shortly after the key request and response, and the wireless device 702 and AMP wireless device 704 can continue using the key from the previous transaction due to the AMP wireless device 704 remaining powered on from the energizing signal (such as from harvesting enough energy to perform these back-to-back transactions).

At 724, the wireless device 702 may perform an integrity check, decryption, or both, on the operational response message. Such procedures may enable the wireless device 702 to verify (for example, validate) that the response message is from the AMP wireless device 704 and not from another (potentially malicious) device. Accordingly, the described security techniques may enable efficient authentication of messages sent from the AMP wireless device 704.

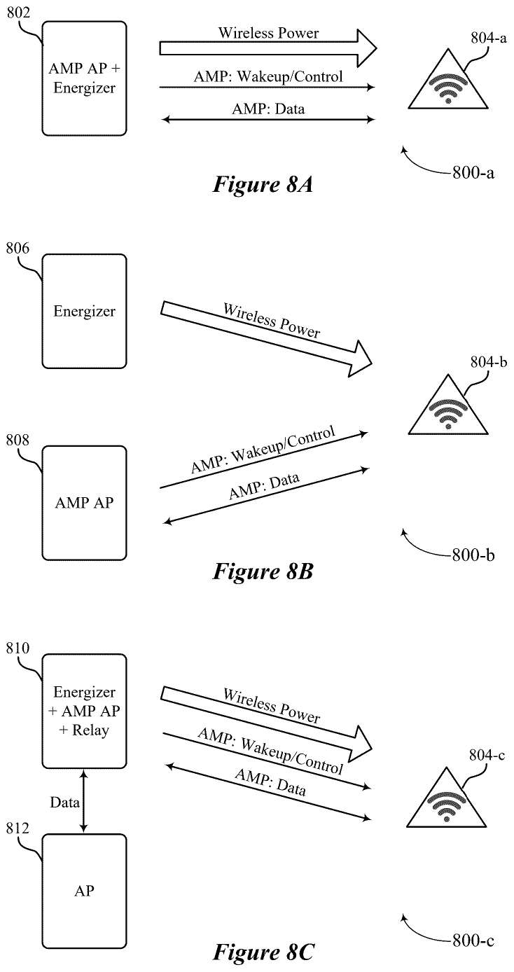

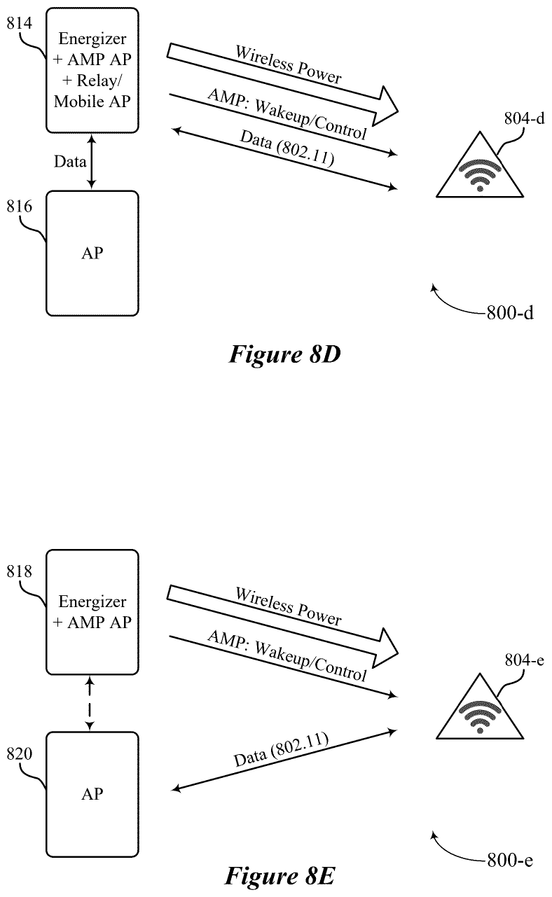

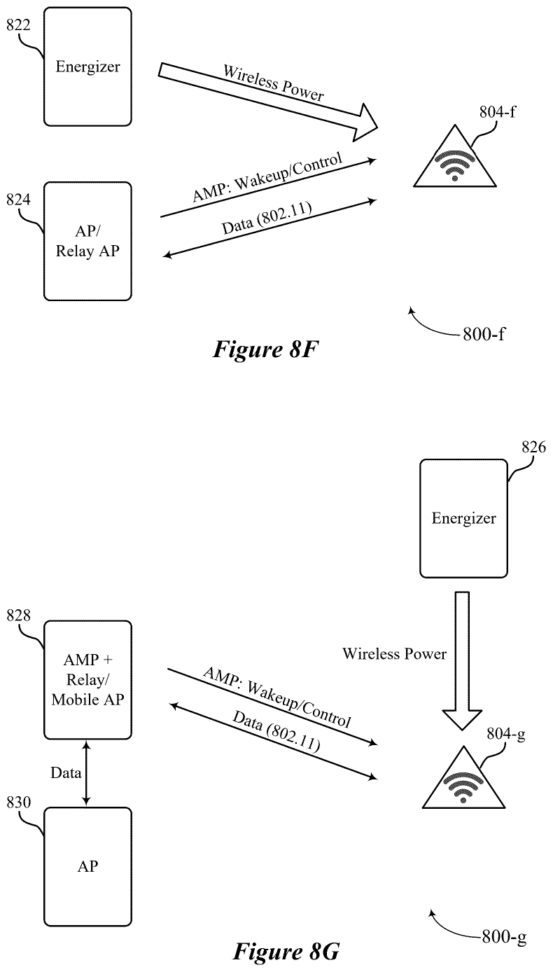

FIGS. 8A, 8B, 8C, 8D, 8E, 8F and 8G show example signaling diagrams 800 (for example, 800-a, 800-b, 800-c, 800-d, 800-e, 800-f, and 800-g) that support secure end-to-end signaling for ambient power devices. In some aspects, the signaling diagrams 800 may be examples of networks that support ambient power-enabled wireless communications. As such, each signaling diagram 800 may be an example of a respective deployment or configuration of one or more devices that enable the ambient power-enabled wireless communications. For example, each signaling diagram 800 may include at least one AMP wireless device 804 (for example, an energy-harvesting device, an AMP tag, a low-power device, an AMP IoT device, or an AMP device) and one or more other devices that provide an energizing signal (for example, an energizer signal) to the AMP wireless device 804 or communicate data with the AMP wireless device 804.

In some cases, an AMP wireless device 804 may support or have one or more types of configurations for wireless communications. For example, in a first type of configuration of the AMP wireless device 804, the AMP wireless device 804 may only include RF components for ambient power-enabled communications (for example, an ambient power radio, or AMP radio). Here, the AMP wireless device 804 may lack support of, or functionality for, some types of data (for example, TCP data, IP data, or QoS data). In such cases, the AMP wireless device 804 may communicate data with one or more other devices using the RF components associated with the ambient power-enabled communications (for example, associated with energy harvesting or other low-power communication techniques). In a second type of configuration of the AMP wireless device 804, the AMP wireless device 804 may only include the RF components for the ambient-power-enabled communications but may support the exchange of various types of data frames for communicating data (such as TCP data frames, IP data frames, QoS data frames, among other examples). In a third type of configuration, the AMP wireless device 804 may include the RF components associated with the ambient power-enabled communications, as well as RF components that support wireless communications in accordance with the IEEE 802.11 family of wireless communication protocol standards (for example, a main radio, an 802.11-capable radio, or the like). In such examples, the AMP wireless device 804 may support the ambient power-enabled communications and various types of data transmission (such as TCP data, IP data, QoS data, among other examples) using one or more sets of RF components.

As illustrated in the pictorial diagram of FIG. 8A, the example signaling diagram 800-a may include a wireless communication device 802 and an AMP wireless device 804-a. The wireless communication device 802 may provide power to the AMP wireless device 804-a and communicate control signals or data with the AMP wireless device 804-a. For example, the wireless communication device 802 may transmit one or more signals (for example, energizing signals) that are used by the AMP wireless device 804-a to harvest energy from the signal(s) and supply power to one or more RF components of the AMP wireless device 804-a for communications with the wireless communication device 802. Further, after the AMP wireless device 804-a supplies power to the one or more RF components (for example, powers up at least one AMP radio) using the harvested energy, the wireless communication device 802 may transmit one or more wakeup signals or control signals for enabling communications between the AMP wireless device 804-a and the wireless communication device 802. The wakeup signals or control signals may be received or processed by the AMP wireless device 804-a via RF components associated with the ambient power-enabled communications (for example, an AMP radio, or an AMP transceiver). The AMP wireless device 804-a may communicate data with the wireless communication device 802 via the AMP radio. In some examples, if there is no data to be communicated, the one or more energizing signals may be stopped (for example, paused, halted, or interrupted), and the AMP wireless device 804-a may subsequently power down (for example, due to an absence of power available for harvesting, until the one or more energizing signals are transmitted/received again). In some examples, one or more servers may be connected to or otherwise in communication with the wireless communication device 802. In such examples, the one or more servers may communicate with the wireless communication device 802, such as one or more query messages or one or more response messages associated with communicating with the AMP wireless device 804-a.

In some examples, the wireless communication device 802 may be referred to as a reader, AMP reader, or reader device, and the wireless communication device 802 may be an example of an AP (such as an AP 102), a network entity, a STA (such as a STA 104), a handheld device, a smart phone, a specialized AMP reader, or another device. Additionally, or alternatively, the wireless communication device 802 may be referred to as an AMP AP or energizer, which may support both the transmission of energizing signals to the AMP wireless device 804-a and data exchange with the AMP wireless device 804-a.

In FIG. 8B, the pictorial diagram of the example signaling diagram 800-b includes at least one energizer device 806 and at least one wireless communication device 808, where the energizer device 806 and the wireless communication device 808 are configured to support ambient power-enabled communications with an AMP wireless device 804-b. The energizer device 806 (for example, energizer) may be configured to transmit one or more signals (for example, energizing signals) that are used by the AMP wireless device 804-b to harvest energy and supply power to one or more RF components of the AMP wireless device 804-a for communications with the wireless communication device 808. In such cases, the energizer device 806 may enable persistent or semi-persistent energy harvesting (for example, relatively long-term energy harvesting) for the AMP wireless device 804-b. As such, the AMP wireless device 804-b may be supplied with power in an approximately continuous manner, thereby enabling extended communications sessions (for example, the communication sessions may be expected to be maintained for some duration).

After the AMP wireless device 804-b supplies power to the one or more RF components (for example, powers up at least one AMP radio) using the energizing signal(s) from the energizer device 806, the wireless communication device 808 may transmit one or more wakeup signals, control signals, or both, to enable communications between the AMP wireless device 804-b and the wireless communication device 808. The wakeup signals, control signals, or both, may be received or processed by the AMP wireless device 804-b using one or more RF components associated with the ambient power-enabled communications (for example, an AMP radio, or an AMP transceiver). The AMP wireless device 804-b may communicate data with the wireless communication device 808 via the AMP radio.

The energizer device 806 may be an example of an AP (such as an AP 102), a network entity, a STA (such as a STA 104), a handheld device, a smart phone, a specialized AMP device, or another device. The wireless communication device 808 may be referred to as a reader, AMP reader, or reader device, and the wireless communication device 808 may be an example of an AP (such as an AP 102), a network entity, a STA (such as a STA 104), a handheld device, a smart phone, a specialized AMP reader, or another device. Additionally, or alternatively, the wireless communication device 808 may be referred to as an AMP AP, which supports the exchange of data with the AMP wireless device 804-b.

The pictorial diagram of the example signaling diagram 800-c shown in FIG. 8C may illustrate a configuration of one or more relay or relay-like devices that enable ambient power-enabled communication with an AMP wireless device 804-c. For example, the signaling diagram 800-c may include a first wireless communication device 810 in communication with a second wireless communication device 812, where data may be communicated between the second wireless communication device 812 and the AMP wireless device 804-c via the first wireless communication device 810.

The first wireless communication device 810 may transmit one or more signals (for example, energizing signals) that are used by the AMP wireless device 804-c to harvest energy from the signal(s) and supply power to one or more RF components of the AMP wireless device 804-c for communications with the first wireless communication device 810. After the AMP wireless device 804-c supplies power to the one or more RF components (for example, powers up at least one AMP radio) using the harvested energy from the first wireless communication device 810, the first wireless communication device 810 may transmit one or more wakeup signals, control signals, or both, for enabling communications between the AMP wireless device 804-c and the first wireless communication device 810. In some examples, the transmission of the wakeup signals, control signals, or both, may be triggered by the second wireless communication device 812, for example, when the second wireless communication device 812 has data to transmit to the AMP wireless device 804-c or when the second wireless communication device 812 initiates the retrieval of data from the AMP wireless device 804-c. As such, the first wireless communication device 810 may function as a relay for the second wireless communication device 812, the AMP wireless device 804-c, or both. Additionally, or alternatively, the first wireless communication device 810 may communicate with the AMP wireless device 804-c without relaying data to/from the second wireless communication device 812. The wakeup signals, control signals, or both, may be received or processed by the AMP wireless device 804-c using RF components associated with the ambient power-enabled communications (such as an AMP radio, or an AMP transceiver). The AMP wireless device 804-c may communicate data with the first wireless communication device 810 via the AMP radio.

The first wireless communication device 810 may be an example of an AP (such as an AP 102), a network entity, a STA (such as a STA 104), a handheld device, a smart phone, a specialized AMP reader, or another device. The first wireless communication device 810 may, in some cases, be referred to as a reader or an AMP reader. Additionally, or alternatively, the first wireless communication device 810 may be referred to as an AMP AP, a mobile AP, a relay AP, an energizer, or a relay (such as a Wi-Fi relay, or an 802.11 relay) that supports relaying and exchange of data with the AMP wireless device 804-c, the second wireless communication device 812, or both. The second wireless communication device 812 may be an example of an AP (such as an AP 102), a network entity, a STA (such as a STA 104), a handheld device, a smart phone, or another device. Additionally, or alternatively, the second wireless communication device 812 may be referred to as an 802.11 AP or some similar terminology, where the second wireless communication device 812 may support the exchange of data with the AMP wireless device 804-c.

The pictorial diagram of the example signaling diagram 800-d shown in FIG. 8D may illustrate another configuration of one or more relay or relay-like devices that enable ambient power-enabled communication with an AMP wireless device 804-d. For example, the signaling diagram 800-d may include a first wireless communication device 814 in communication with a second wireless communication device 816, where data may be communicated between the second wireless communication device 816 and the AMP wireless device 804-d via the first wireless communication device 814. In the example of the signaling diagram 800-d, the data may be associated with the IEEE 802.11 wireless communication protocol standards.

In some examples, the first wireless communication device 814 may transmit one or more signals (for example, energizing signals) that are used by the AMP wireless device 804-d to harvest energy from the signal(s) and supply power to one or more RF components of the AMP wireless device 804-d for communications with the first wireless communication device 814. After the AMP wireless device 804-d supplies power to the one or more RF components (for example, powers up at least one radio, such as a main radio, an 802.11-capable radio, or the like) using the harvested energy from the signal(s) from the first wireless communication device 814, the first wireless communication device 814 may transmit one or more wakeup signals, control signals, or both, for enabling communications between the AMP wireless device 804-d and the first wireless communication device 814. The wakeup signals, control signals, or both, may be received or processed by the AMP wireless device 804-d using RF components associated with the ambient power-enabled communications (for example, an AMP radio, or an AMP transceiver). In some examples, the first wireless communication device 814 may function as a WLAN relay, and the first wireless communication device 814 may support one or more functions for initiating AMP wake up on an AMP radio for downlink packets.

In some examples, the transmission of the wakeup signals, control signals, or both, may be triggered by the second wireless communication device 816, for example, when the second wireless communication device 816 has data to transmit to the AMP wireless device 804-d or when the second wireless communication device 816 initiates the retrieval of data from the AMP wireless device 804-d. As such, the first wireless communication device 814 may function as a relay for the second wireless communication device 816, the AMP wireless device 804-d, or both. Additionally, or alternatively, the first wireless communication device 814 may communicate with the AMP wireless device 804-d without relaying data to/from the second wireless communication device 816. In some examples, the AMP wireless device 804-d may include both the AMP radio/RF components and one or more RF components associated with communicating 802.11 data (for example, a main radio, an 802.11-capable radio, or the like). In such examples, the AMP wireless device 804-d may communicate 802.11 data with the first wireless communication device 814 via the main radio. In some examples, the 802.11 data may be sent to the second wireless communication device 816 via the first wireless communication device 814. Additionally, or alternatively, the 802.11 data may be sent to the AMP wireless device 804-d from the second wireless communication device 816 via the first wireless communication device 814.

The first wireless communication device 814 may be an example of an AP (such as an AP 102), a network entity, a STA (such as a STA 104), a handheld device, a smart phone, a specialized AMP reader, or another device. The first wireless communication device 814 may, in some examples, be referred to as a reader. Additionally, or alternatively, the first wireless communication device 814 may be referred to as an AMP AP, a mobile AP, a relay AP, an energizer, or a relay (for example, a Wi-Fi relay, or an 802.11 relay) that supports relaying and exchange of data with the AMP wireless device 804-d or the second wireless communication device 816. The second wireless communication device 816 may be an example of an AP (such as an AP 102), a network entity, a STA (such as a STA 104), a handheld device, a smart phone, or another device. Additionally, or alternatively, the second wireless communication device 816 may be referred to as an 802.11 AP or some similar terminology, and the second wireless communication device 816 may support the exchange of data with the AMP wireless device 804-d.

As shown in the pictorial diagram of the example signaling diagram 800-e of FIG. 8E, respective devices may provide energizing signals and communicate data with an AMP wireless device 804-e. For example, the signaling diagram 800-e may include a first wireless communication device 818 and a second wireless communication device 820. The first wireless communication device 818 may provide one or more signals (for example, energizing signals, wakeup signals, control signals, or any combination thereof) to the AMP wireless device 804-e, whereas data may be communicated (for example, directly communicated) between the second wireless communication device 820 and the AMP wireless device 804-e. In the example of the signaling diagram 800-e, the data may be associated with the IEEE 802.11 wireless communication protocol standards (for example, 802.11 data).

As an example, the first wireless communication device 818 may transmit one or more signals (for example, energizing signals) that are used by the AMP wireless device 804-e for energy harvesting and to supply power to one or more RF components of the AMP wireless device 804-e for communications with the second wireless communication device 820. After the AMP wireless device 804-e supplies power to the one or more RF components (for example, powers up at least one radio/transceiver, such as an AMP radio, a main radio, an 802.11-capable radio, or the like) using the harvested energy from the first wireless communication device 818, the first wireless communication device 818 may transmit one or more wakeup signals, control signals, or both, for enabling communications between the AMP wireless device 804-e and the second wireless communication device 820. In some examples, the wakeup signals, control signals, or both, may be received and/or processed by the AMP wireless device 804-e using RF components associated with the ambient power-enabled communications (for example, the AMP radio, or an AMP transceiver).

In some examples, the transmission of the wakeup signals, control signals, or both, may be coordinated with the second wireless communication device 820. For example, the first wireless communication device 818 and the second wireless communication device 820 may optionally communicate with one another and the energizing signals, the wakeup signals, the control signals, or both, may be transmitted to the AMP wireless device 804-e when the second wireless communication device 820 is to communicate data (such as 802.11 data) with the AMP wireless device 804-e. In such examples, the AMP wireless device 804-e may include both the AMP radio/RF components and one or more RF components associated with communicating 802.11 data (such as a main radio, an 802.11-capable radio, or the like). The AMP wireless device 804-e may communicate 802.11 data with the second wireless communication device 820 via the main radio, whereas the energizing signals, wakeup signals, control signals, or both, may be communicated via the AMP radio. The 802.11 data may be exchanged between the second wireless communication device 820 and the AMP wireless device 804-e without being relayed via the first wireless communication device 818.

The first wireless communication device 818 may be an example of an AP (such as an AP 102), a network entity, a STA (such as a STA 104), a handheld device, a smart phone, a specialized AMP reader, or another device. The first wireless communication device 818 may, in some examples, be referred to as a reader or AMP reader. Additionally, or alternatively, the first wireless communication device 818 may be referred to as an AMP AP, a mobile AP, or an energizer. The second wireless communication device 820 may be an example of an AP (such as an AP 102), a network entity, a STA (such as a STA 104), a handheld device, a smart phone, or another device. Additionally, or alternatively, the second wireless communication device 820 may be referred to as an 802.11 AP or some similar terminology, and the second wireless communication device 820 may support the exchange of data with the AMP wireless device 804-e.

In FIG. 8F, the pictorial diagram of the signaling diagram 800-f includes respective devices that may provide an energizing signal and communicate data with an AMP wireless device 804-f. For example, the signaling diagram 800-f may include a first wireless communication device 822 and a second wireless communication device 824. The first wireless communication device 822 may provide one or more signals (such as energizing signals) to the AMP wireless device 804-f, which may enable the AMP wireless device 804-f to harvest energy and communicate with one or more other devices. For instance, one or more signals (such as wakeup signals, control signals, or any combination thereof) and data may be communicated (for example, directly communicated) between the second wireless communication device 824 and the AMP wireless device 804-f. In the example of the signaling diagram 800-f, the data may be associated with the IEEE 802.11 wireless communication protocol standards (such as 802.11 data).

As an example, the first wireless communication device 822 may transmit one or more signals (such as energizing signals) that are used by the AMP wireless device 804-f for energy harvesting to supply power to one or more RF components of the AMP wireless device 804-f for communications with the second wireless communication device 824. After the AMP wireless device 804-f supplies power to the one or more RF components (for example, powers up at least one radio, such as an AMP radio, a main radio, an 802.11-capable radio, or the like) using the harvested energy from the first wireless communication device 822, the second wireless communication device 824 may transmit one or more wakeup signals, control signals, or both, for enabling communications between the AMP wireless device 804-f and the second wireless communication device 824. In some examples, the wakeup signals, control signals, or both, may be received or processed by the AMP wireless device 804-f using RF components associated with the ambient power-enabled communications (such as the AMP radio, or an AMP transceiver). In some examples, the AMP wireless device 804-f may include both the AMP radio/RF components and one or more RF components associated with communicating 802.11 data (such as a main radio, an 802.11-capable radio, or the like). In such examples, the AMP wireless device 804-f may communicate 802.11 data with the second wireless communication device 824 via the main radio, whereas the energizing signals, wakeup signals, or control signals may be communicated via the AMP radio. The 802.11 data may be exchanged between the second wireless communication device 824 and the AMP wireless device 804-f without being relayed via the first wireless communication device 822.

The first wireless communication device 822 may be an example of an AP (such as an AP 102), a network entity, a STA (such as a STA 104), a handheld device, a smart phone, a specialized AMP device, or another device. The first wireless communication device 822 may be referred to as an energizer, energizing device, or similar terminology. The second wireless communication device 824 may be an example of an AP (such as an AP 102), a network entity, a STA (such as a STA 104), a handheld device, a smart phone, or another device. Additionally, or alternatively, the second wireless communication device 824 may be referred to as an 802.11 AP, a relay AP (for example, the second wireless communication device 824 may relay data to/from the AMP wireless device 804-f and one or more other devices), or some similar terminology, and the second wireless communication device 824 may support the exchange of data with the AMP wireless device 804-f.

The pictorial diagram of the example signaling diagram 800-g shown in FIG. 8G may illustrate a configuration of one or more relay or relay-like devices that enable ambient power-enabled communication with an AMP wireless device 804-f, as well as one or more devices that are configured to provide one or more energizing signals to the AMP wireless device 804-f. For example, the signaling diagram 800-g may include a first wireless communication device 826, a second wireless communication device 828, and a third wireless communication device 830 in communication with the second wireless communication device 828. Here, data may be communicated between the third wireless communication device 830 and the AMP wireless device 804-g via the second wireless communication device 828.

The first wireless communication device 826 may transmit one or more signals (such as energizing signals) that are used by the AMP wireless device 804-g to harvest energy from the signal(s) and supply power to one or more RF components of the AMP wireless device 804-g for communications with the second wireless communication device 828. After the AMP wireless device 804-g supplies power to the one or more RF components (for example, powers up at least one radio, such as an AMP radio, a main radio, an 802.11-capable radio, or the like) using harvested energy from the first wireless communication device 826, the second wireless communication device 828 may transmit one or more wakeup signals, control signals, or both, for enabling communications between the AMP wireless device 804-g and the second wireless communication device 828. In some examples, the transmission of the wakeup signals, control signals, or both, may be triggered by the third wireless communication device 830, for example, when the third wireless communication device 830 has data to transmit to the AMP wireless device 804-g or when the third wireless communication device 830 initiates the retrieval of data from the AMP wireless device 804-g. The second wireless communication device 828 may, in some examples, perform as a relay for the third wireless communication device 830 or the AMP wireless device 804-g. Additionally, or alternatively, the second wireless communication device 828 may communicate with the AMP wireless device 804-g without relaying data to/from the third wireless communication device 830. The wakeup signals, control signals, or both, may be received or processed by the AMP wireless device 804-g using RF components associated with the ambient power-enabled communications (such as an AMP radio, or an AMP transceiver). In some examples, the AMP wireless device 804-g may include both the AMP radio/RF components and one or more RF components associated with communicating 802.11 data (such as a main radio, an 802.11-capable radio, or the like). The AMP wireless device 804-g may communicate 802.11 data with the second wireless communication device 828 via the main radio. In some examples, the 802.11 data may be sent to the third wireless communication device 830 via the second wireless communication device 828 (such as while the first wireless communication device 826 provides the energizing signa(s)). Additionally, or alternatively, the 802.11 data may be sent to the AMP wireless device 804-g from the third wireless communication device 830 via the second wireless communication device 828 (such as while the first wireless communication device 826 provides the energizing signa(s)).

The first wireless communication device 826 may be an example of an AP (such as an AP 102), a network entity, a STA (such as a STA 104), a handheld device, a smart phone, a specialized AMP reader, or another device. The first wireless communication device 810 may, in some examples, be referred to as an energizer or energizing device. In some examples, the second wireless communication device 828 may be an example of an AP (such as an AP 102), a network entity, a STA (such as a STA 104), a handheld device, a smart phone, a specialized AMP reader, or another device. Additionally, or alternatively, the second wireless communication device 828 may be referred to as an AMP AP, a mobile AP, a relay AP, or a relay (such as a Wi-Fi relay, or an 802.11 relay) that supports relaying and exchange of data with the AMP wireless device 804-g, the third wireless communication device 830, or both. The third wireless communication device 830 may be an example of an AP (such as an AP 102), a network entity, a STA (such as a STA 104), a handheld device, a smart phone, or another device. Additionally, or alternatively, the third wireless communication device 830 may be referred to as an 802.11 AP or some similar terminology.

As described with reference to one or more of the signaling diagrams 800, respective examples or scenarios may be possible for ambient power-enabled communications. In some examples, the secure communication between the AP and the AMP wireless device 804 may be affected by the network configuration, and may depend on how the AMP AP, energizer, and Legacy AP are placed (for example, if they are colocated or non-colocated). In some examples, such as the example of FIG. 8E, the AMP wireless device 804-e may communicate 802.11 data with the second wireless communication device 820, whereas the energizing signals, wakeup signals, or control signals may be communicated via the first wireless communication device 818. In such an implementation, the second wireless communication device 820 can provide a common PMK in a secure manner to the first wireless communication device 818 and the AMP wireless device 804-e using an 802.11 link. Such a common key may be used as the PMK, which the AMP wireless device 804-e will use to generate the PTK, and the first wireless communication device 818 will use for integrity check, decryption, or both, of a response sent by the AMP wireless device 804-e to an operational message (such as an operation mode request or a trigger frame). Further, since the AMP wireless device 804-e has ability to do 802.11 transmissions, it is possible that the AMP wireless device 804-e is co-located with an 802.11 client, and thus, the AMP wireless device 804-e in this case may have a larger non-volatile memory compared to AMP-only client, but may still have limited energy constraint. In some examples, the AMP wireless device 804-e may have a capability to store the transient key to use over multiple transactions. Further, the keys for AMP communication (such as for AMP wakeup and control) can be provided securely over the already established 802.11 link.

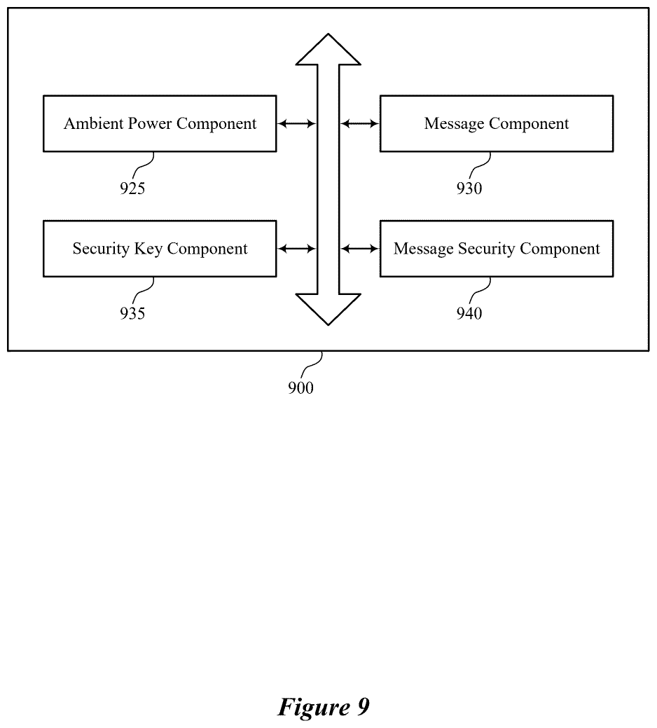

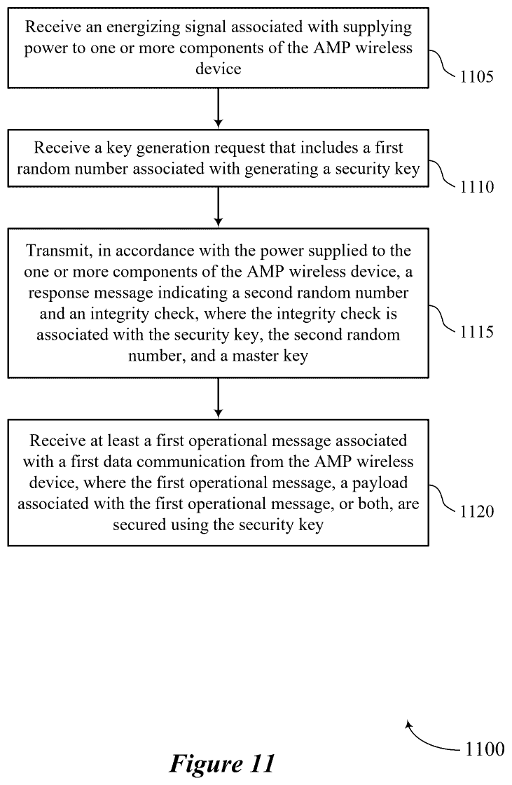

FIG. 9 shows a block diagram of an example wireless communication device 900 that supports secure end-to-end signaling for ambient power devices. In some examples, the wireless communication device 900 is configured to perform the process 1100 described with reference to FIG. 11. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes an ambient power component 925, a message component 930, a security key component 935, and a message security component 940.

Portions of one or more of the ambient power component 925, the message component 930, the security key component 935, and the message security component 940 may be implemented at least in part in hardware or firmware. For example, one or more of the ambient power component 925, the message component 930, the security key component 935, and the message security component 940 may be implemented at least in part by at least a processor or a modem. In some examples, portions of one or more of the ambient power component 925, the message component 930, the security key component 935, and the message security component 940 may be implemented at least in part by a processor and software in the form of processor-executable code stored in memory.

The wireless communication device 900 may support wireless communications in accordance with examples as disclosed herein. The ambient power component 925 is configurable or configured to receive an energizing signal associated with supplying power to one or more components of the AMP wireless device. The message component 930 is configurable or configured to receive a key generation request that includes a first random number associated with generating a security key. The security key component 935 is configurable or configured to transmit, in accordance with the power supplied to the one or more components of the AMP wireless device, a response message indicating a second random number and an integrity check, where the integrity check is associated with the security key, the second random number, and a master key. The message security component 940 is configurable or configured to receive at least a first operational message associated with a first data communication from the AMP wireless device, where the first operational message, a payload associated with the first operational message, or both, are secured using the security key.

In some examples, the security key component 935 is configurable or configured to generate the second random number in response to the key generation request, where the security key is specific to the received key generation request.

In some examples, the security key is a pairwise transient key (PTK) that includes a key confirmation key (KCK) and a temporal key (TK).

In some examples, at least an information portion the first operational message is encrypted using the PTK, and the message security component 940 is configurable or configured to decrypt the first operational message using the PTK, and transmit an operational response message in accordance with an indication in the first operational message.

In some examples, the first operational message further includes a message integrity check portion that includes a first integrity check that is generated using the information portion and the KCK.

In some examples, the first operational message is unencrypted and includes an information portion and a message integrity check portion that includes a first integrity check that is generated using the information portion and the KCK, and the message security component 940 is configurable or configured to transmit an operational response message in accordance with the information portion when a second integrity check computed at the AMP wireless device matches the first integrity check, and to discard the first operational message when the second integrity check is different than the first integrity check.

In some examples, the first operational message is an operation mode request message, and the message component 930 is configurable or configured to transmit, in response to the operation mode request message, an operation mode response message that provides operational details associated with the AMP wireless device.

In some examples, the key generation request further indicates an operation mode request for operational details associated with the AMP wireless device. In some examples, the response message indicates the second random number, the integrity check, and an operation mode response that provides the operational details associated with the AMP wireless device.

In some examples, the security key component 935 is configurable or configured to receive, subsequent to transmitting the response message and prior to receiving the first operational message, a key confirmation message that indicates that the security key is synchronized between the AMP wireless device and an associated access point.

In some examples, the first operational message is a trigger message, and the message security component 940 is configurable or configured to transmit a trigger response with a data payload associated with the trigger message, where the trigger response is secured using the security key.

In some examples, the key generation request further includes a trigger message for the AMP wireless device. In some examples, the response message indicates the second random number, the integrity check, and includes a data payload associated with the trigger message.

In some examples, the key generation request is received from an AMP access point (AP) that provides an energizing signal to the AMP wireless device, and the response message is transmitted to a non-AMP AP that is different from the AMP AP.

In some examples, the AMP wireless device is co-located with a non-AMP wireless device, and the security key component 935 is configurable or configured to receive, from a non-AMP access point (AP), at least the master key, store the security key and the master key in a persistent memory associated with the AMP wireless device, and communicate with one or more of the non-AMP wireless device or the non-AMP AP in accordance with the stored security key and master key, where the stored security key and master key are associated with multiple different energizing signals associated with supplying power to one or more components of the AMP wireless device.

In some examples, a set of multiple messages are received at the AMP wireless device from an interrogating device, the set of multiple messages unassociated with subsequent operational messages, and the AMP wireless device discontinues transmitting response messages to the interrogating device.

In some examples, the first operational message is a trigger message, and the message security component 940 is configurable or configured to receive a set of multiple trigger messages within a time period, transmit a set of multiple trigger response messages associated with the set of multiple trigger messages, and discontinue transmission of trigger response messages when a quantity of trigger messages within the time period exceeds a threshold value.

In some examples, the first operational message is a trigger message, and the message security component 940 is configurable or configured to receive a set of multiple trigger messages, and transmit a trigger response message to one or more randomly selected trigger messages of the set of multiple trigger messages.

In some examples, the message security component 940 is configurable or configured to receive a second operational message that indicates one or more prior response messages were not received at an associated access point (AP). In some examples, the message security component 940 is configurable or configured to transmit a response that indicates that the AMP wireless device was unable to transmit the one or more prior response messages, or that the one or more prior response messages were transmitted by the AMP wireless device.

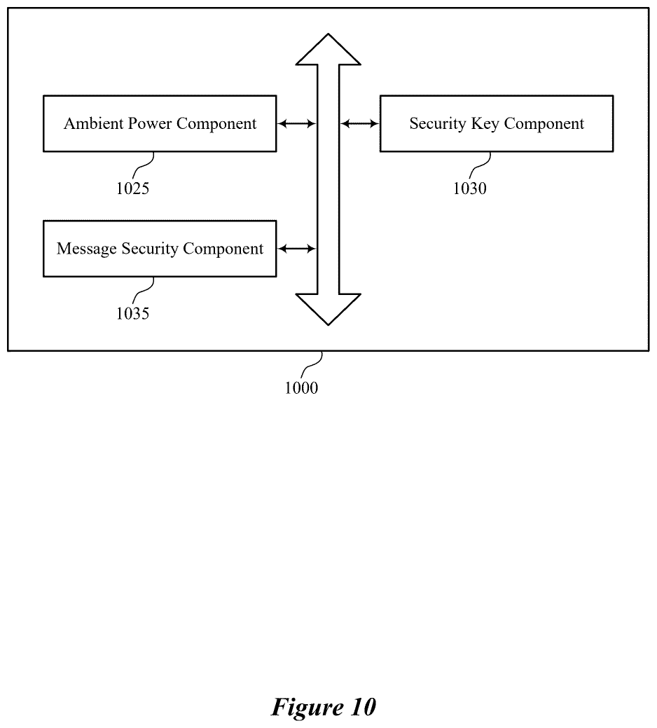

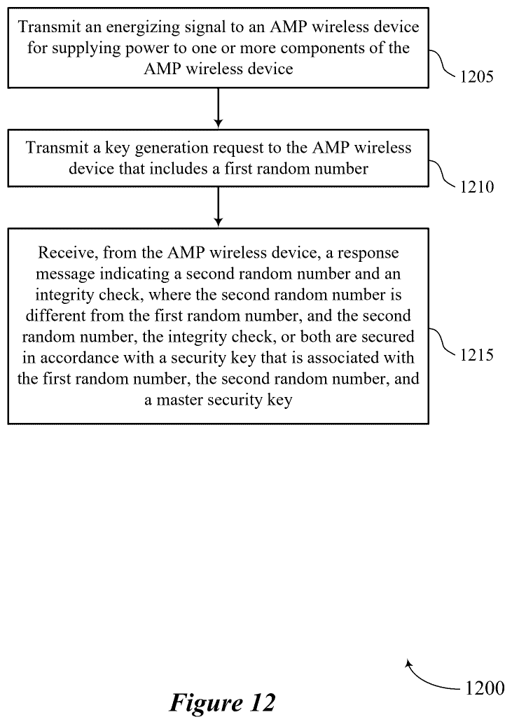

FIG. 10 shows a block diagram of an example wireless communication device 1000 that supports secure end-to-end signaling for ambient power devices. In some examples, the wireless communication device 1000 is configured to perform the process 1200 described with reference to FIG. 12. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an ambient power component 1025, a security key component 1030, and a message security component 1035. Portions of one or more of the ambient power component 1025, the security key component 1030, and the message security component 1035 may be implemented at least in part in hardware or firmware. For example, one or more of the ambient power component 1025, the security key component 1030, and the message security component 1035 may be implemented at least in part by at least a processor or a modem. In some examples, portions of one or more of the ambient power component 1025, the security key component 1030, and the message security component 1035 may be implemented at least in part by a processor and software in the form of processor-executable code stored in memory.

The wireless communication device 1000 may support wireless communications in accordance with examples as disclosed herein. The ambient power component 1025 is configurable or configured to transmit an energizing signal to an AMP wireless device for supplying power to one or more components of the AMP wireless device. The security key component 1030 is configurable or configured to transmit a key generation request to the AMP wireless device that includes a first random number. The message security component 1035 is configurable or configured to receive, from the AMP wireless device, a response message indicating a second random number and an integrity check, where the second random number is different from the first random number, and the second random number, the integrity check, or both are secured in accordance with a security key that is associated with the first random number, the second random number, and a master security key.

In some examples, the message security component 1035 is configurable or configured to transmit, to the AMP wireless device, at least a first operational message associated with a first data communication of the AMP wireless device, where the first operational message, a payload associated with the first operational message, or both, are secured using the security key.

In some examples, the security key component 1030 is configurable or configured to generate the security key in accordance with the first random number, the second random number, and the master key, where the security key is specific to the key generation request.

In some examples, the security key is a pairwise transient key (PTK) that includes a key confirmation key (KCK) and a temporal key (TK).

In some examples, the message security component 1035 is configurable or configured to encrypt at least an information portion of a first operational message using the PTK. In some examples, the message security component 1035 is configurable or configured to transmit the encrypted first operational message to the AMP wireless device. In some examples, the message security component 1035 is configurable or configured to receive an operational response message from the AMP wireless device in accordance with an indication in the first operational message, where the operational response message is encrypted using the PTK.

In some examples, the first operational message further includes a message integrity check portion that includes a first integrity check that is generated using the information portion and the KCK.

In some examples, the message security component 1035 is configurable or configured to transmit a first operational message, including an information portion and a message integrity check that is generated using the information portion and the KCK, to the AMP wireless device, where the first operational message is unencrypted.

In some examples, the message security component 1035 is configurable or configured to transmit an operation mode request message to the AMP wireless device, where the operation mode request message, a payload associated with the operation mode request message, or both, are secured using the security key. In some examples, the message security component 1035 is configurable or configured to receive, in response to the operation mode request message, an operation mode response message that provides operational details associated with the AMP wireless device, where the operation mode response message, a payload associated with the operation mode response message, or both, are secured using the security key.

In some examples, the key generation request further indicates an operation mode request for operational details associated with the AMP wireless device. In some examples, the response message indicates the second random number, the integrity check, and an operation mode response that provides the operational details associated with the AMP wireless device.

In some examples, the security key component 1030 is configurable or configured to transmit, subsequent to receiving the response message and prior to transmitting a first operational message, a key confirmation message that indicates that the security key is synchronized between the AMP wireless device and the AP.

In some examples, the message security component 1035 is configurable or configured to transmit a trigger message to the AMP wireless device, where the trigger message, a payload associated with the trigger message, or both, are secured using the security key. In some examples, the message security component 1035 is configurable or configured to receive a trigger response with a data payload associated with the trigger message, where the trigger response, the payload, or both, are secured using the security key.

In some examples, the key generation request further includes a trigger message for the AMP wireless device. In some examples, the response message indicates the second random number, the integrity check, and includes a data payload associated with the trigger message.

In some examples, the message security component 1035 is configurable or configured to transmit a set of multiple operational messages to the AMP wireless device. In some examples, the message security component 1035 is configurable or configured to transmit, in response to one or more response messages associated with the set of multiple operational message being undetected at the AP, a second operational message to the AMP wireless device that indicates the one or more response messages were not received at the AP. In some examples, the message security component 1035 is configurable or configured to receive a response from the AMP wireless device that indicates the one or more response messages were transmitted by the AMP wireless device. In some examples, the message security component 1035 is configurable or configured to modify one or more of a start time or a duration of an energizing signal associated with one or more operational messages.

FIG. 11 shows a flowchart illustrating an example process 1100 performable by or at an AMP wireless device that supports secure end-to-end signaling for ambient power devices. The operations of the process 1100 may be implemented by an AMP wireless device or its components as described herein. For example, the process 1100 may be performed by a wireless communication device, such as the wireless communication device 900 described with reference to FIG. 9, operating as or within a wireless STA. In some examples, the process 1100 may be performed by a wireless STA, such as one of the STAs 104 described with reference to FIG. 1.

In some examples, in 1105, the AMP wireless device may receive an energizing signal associated with supplying power to one or more components of the AMP wireless device. The operations of 1105 may be performed in accordance with examples as disclosed herein. In some implementations, aspects of the operations of 1105 may be performed by an ambient power component 925 as described with reference to FIG. 9.

In some examples, in 1110, the AMP wireless device may receive a key generation request that includes a first random number associated with generating a security key. The operations of 1110 may be performed in accordance with examples as disclosed herein. In some implementations, aspects of the operations of 1110 may be performed by a message component 930 as described with reference to FIG. 9.

In some examples, in 1115, the AMP wireless device may transmit, in accordance with the power supplied to the one or more components of the AMP wireless device, a response message indicating a second random number and an integrity check, where the integrity check is associated with the security key, the second random number, and a master key. The operations of 1115 may be performed in accordance with examples as disclosed herein. In some implementations, aspects of the operations of 1115 may be performed by a security key component 935 as described with reference to FIG. 9.

In some examples, in 1120, the AMP wireless device may receive at least a first operational message associated with a first data communication from the AMP wireless device, where the first operational message, a payload associated with the first operational message, or both, are secured using the security key. The operations of 1120 may be performed in accordance with examples as disclosed herein. In some implementations, aspects of the operations of 1120 may be performed by a message security component 940 as described with reference to FIG. 9.

FIG. 12 shows a flowchart illustrating an example process 1200 performable by or at an AP that supports secure end-to-end signaling for ambient power devices. The operations of the process 1200 may be implemented by an AP or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in 1205, the AP may transmit an energizing signal to an AMP wireless device for supplying power to one or more components of the AMP wireless device. The operations of 1205 may be performed in accordance with examples as disclosed herein. In some implementations, aspects of the operations of 1205 may be performed by an ambient power component 1025 as described with reference to FIG. 10.

In some examples, in 1210, the AP may transmit a key generation request to the AMP wireless device that includes a first random number. The operations of 1210 may be performed in accordance with examples as disclosed herein. In some implementations, aspects of the operations of 1210 may be performed by a security key component 1030 as described with reference to FIG. 10.

In some examples, in 1215, the AP may receive, from the AMP wireless device, a response message indicating a second random number and an integrity check, where the second random number is different from the first random number, and the second random number, the integrity check, or both are secured in accordance with a security key that is associated with the first random number, the second random number, and a master security key. The operations of 1215 may be performed in accordance with examples as disclosed herein. In some implementations, aspects of the operations of 1215 may be performed by a message security component 1035 as described with reference to FIG. 10.

Implementation examples are described in the following numbered clauses:
Clause 1: A method for wireless communications at an AMP wireless device, including: receiving an energizing signal associated with supplying power to one or more components of the AMP wireless device; receiving a key generation request that includes a first random number associated with generating a security key; transmitting, in accordance with the power supplied to the one or more components of the AMP wireless device, a response message indicating a second random number and an integrity check, where the integrity check is associated with the security key, the second random number, and a master key; and receiving at least a first operational message associated with a first data communication from the AMP wireless device, where the first operational message, a payload associated with the first operational message, or both, are secured using the security key.
Clause 2: The method of clause 1, further including: generating the second random number in response to the key generation request, where the security key is specific to the received key generation request.
Clause 3: The method of any of clauses 1 through 2, where the security key is a PTK that includes a KCK and a TK.
Clause 4: The method of clause 3, where at least an information portion the first operational message is encrypted using the PTK, and where the method further includes: decrypting the first operational message using the PTK; and transmitting an operational response message in accordance with an indication in the first operational message.
Clause 5: The method of clause 4, where the first operational message further includes a message integrity check portion that includes a first integrity check that is generated using the information portion and the KCK.
Clause 6: The method of clause 3, where the first operational message is unencrypted and includes an information portion and a message integrity check portion that includes a first integrity check that is generated using the information portion and the KCK, and where the method further includes: transmitting an operational response message in accordance with the information portion when a second integrity check computed at the AMP wireless device matches the first integrity check; and discarding the first operational message when the second integrity check is different than the first integrity check.
Clause 7: The method of any of clauses 1 through 6, where the first operational message is an operation mode request message, and where the method further includes: transmitting, in response to the operation mode request message, an operation mode response message that provides operational details associated with the AMP wireless device.
Clause 8: The method of any of clauses 1 through 3, where the key generation request further indicates an operation mode request for operational details associated with the AMP wireless device, and the response message indicates the second random number, the integrity check, and an operation mode response that provides the operational details associated with the AMP wireless device.
Clause 9: The method of any of clauses 1 through 7, further including: receiving, subsequent to transmitting the response message and prior to receiving the first operational message, a key confirmation message that indicates that the security key is synchronized between the AMP wireless device and an associated access point.
Clause 10: The method of any of clauses 1 through 9, where the first operational message is a trigger message, and where the method further includes: transmitting a trigger response with a data payload associated with the trigger message, where the trigger response is secured using the security key.
Clause 11: The method of any of clauses 1 through 3, where the key generation request further includes a trigger message for the AMP wireless device, and the response message indicates the second random number, the integrity check, and includes a data payload associated with the trigger message.
Clause 12: The method of any of clauses 1 through 11, where the key generation request is received from an AMP AP that provides an energizing signal to the AMP wireless device, and the response message is transmitted to a non-AMP AP that is different from the AMP AP.
Clause 13: The method of any of clauses 1 through 11, where the AMP wireless device is co-located with a non-AMP wireless device, and where the method further includes: receiving, from a non-AMP AP, at least the master key; storing the security key and the master key in a persistent memory associated with the AMP wireless device; and communicating with one or more of the non-AMP wireless device or the non-AMP AP in accordance with the stored security key and master key, where the stored security key and master key are associated with multiple different energizing signals associated with supplying power to one or more components of the AMP wireless device.
Clause 14: The method of any of clauses 1 through 13, where a set of multiple of messages are received at the AMP wireless device from an interrogating device, the set of multiple of messages unassociated with subsequent operational messages, and the AMP wireless device discontinues transmitting response messages to the interrogating device.
Clause 15: The method of any of clauses 1 through 6, where the first operational message is a trigger message, and where the method further includes: receiving a set of multiple of trigger messages within a time period; transmitting a set of multiple of trigger response messages associated with the set of multiple of trigger messages; and discontinuing transmission of trigger response messages when a quantity of trigger messages within the time period exceeds a threshold value.
Clause 16: The method of any of clauses 1 through 6, where the first operational message is a trigger message, and where the method further includes: receiving a set of multiple of trigger messages; and transmitting a trigger response message to one or more randomly selected trigger messages of the set of multiple of trigger messages.
Clause 17: The method of any of clauses 1 through 16, further including: receiving a second operational message that indicates one or more prior response messages were not received at an associated AP; and transmitting a response that indicates that the AMP wireless device was unable to transmit the one or more prior response messages, or that the one or more prior response messages were transmitted by the AMP wireless device.
Clause 18: A method for wireless communications at an AP, including: transmitting an energizing signal to an AMP wireless device for supplying power to one or more components of the AMP wireless device; transmitting a key generation request to the AMP wireless device that includes a first random number; and receiving, from the AMP wireless device, a response message indicating a second random number and an integrity check, where the second random number is different from the first random number, and the second random number, the integrity check, or both are secured in accordance with a security key that is associated with the first random number, the second random number, and a master security key.
Clause 19: The method of clause 18, further including: transmitting, to the AMP wireless device, at least a first operational message associated with a first data communication of the AMP wireless device, where the first operational message, a payload associated with the first operational message, or both, are secured using the security key.
Clause 20: The method of any of clauses 18 through 19, further including: generating the security key in accordance with the first random number, the second random number, and the master key, where the security key is specific to the key generation request.
Clause 21: The method of any of clauses 18 through 20, where the security key is a PTK that includes a KCK and a TK.
Clause 22: The method of clause 21, further including: encrypting at least an information portion of a first operational message using the PTK; transmitting the encrypted first operational message to the AMP wireless device; and receiving an operational response message from the AMP wireless device in accordance with an indication in the first operational message, where the operational response message is encrypted using the PTK.
Clause 23: The method of clause 22, where the first operational message further includes a message integrity check portion that includes a first integrity check that is generated using the information portion and the KCK.
Clause 24: The method of clause 21, further including: transmitting a first operational message, including an information portion and a message integrity check that is generated using the information portion and the KCK, to the AMP wireless device, where the first operational message is unencrypted.
Clause 25: The method of any of clauses 18 through 24, further including: transmitting an operation mode request message to the AMP wireless device, where the operation mode request message, a payload associated with the operation mode request message, or both, are secured using the security key; and receiving, in response to the operation mode request message, an operation mode response message that provides operational details associated with the AMP wireless device, where the operation mode response message, a payload associated with the operation mode response message, or both, are secured using the security key.
Clause 26: The method of any of clauses 18 through 25, where the key generation request further indicates an operation mode request for operational details associated with the AMP wireless device, and the response message indicates the second random number, the integrity check, and an operation mode response that provides the operational details associated with the AMP wireless device.
Clause 27: The method of any of clauses 18 through 26, further including: transmitting, subsequent to receiving the response message and prior to transmitting a first operational message, a key confirmation message that indicates that the security key is synchronized between the AMP wireless device and the AP.
Clause 28: The method of any of clauses 18 through 27, further including: transmitting a trigger message to the AMP wireless device, where the trigger message, a payload associated with the trigger message, or both, are secured using the security key; and receiving a trigger response with a data payload associated with the trigger message, where the trigger response, the payload, or both, are secured using the security key.
Clause 29: The method of any of clauses 18 through 25, where the key generation request further includes a trigger message for the AMP wireless device, and the response message indicates the second random number, the integrity check, and includes a data payload associated with the trigger message.
Clause 30: The method of any of clauses 18 through 29, further including: transmitting a set of multiple of operational messages to the AMP wireless device; transmitting, in response to one or more response messages associated with the set of multiple of operational message being undetected at the AP, a second operational message to the AMP wireless device that indicates the one or more response messages were not received at the AP; receiving a response from the AMP wireless device that indicates the one or more response messages were transmitted by the AMP wireless device; and modifying one or more of a start time or a duration of an energizing signal associated with one or more operational messages.
Clause 31: An AMP wireless device including: a processing system that includes processor circuitry and memory circuitry that stores code, the processing system configured to cause the AMP wireless device to: receive an energizing signal associated with supplying power to one or more components of the AMP wireless device; receive a key generation request that includes a first random number associated with generating a security key; transmit, in accordance with the power supplied to the one or more components of the AMP wireless device, a response message indicating a second random number and an integrity check, where the integrity check is associated with the security key, the second random number, and a master key; and receive at least a first operational message associated with a first data communication from the AMP wireless device, where the first operational message, a payload associated with the first operational message, or both, are secured using the security key.
Clause 32: The AMP wireless device of clause 31, where the processing system is further configured to cause the AMP wireless device to: generate the second random number in response to the key generation request, where the security key is specific to the received key generation request.
Clause 33: The AMP wireless device of any of clauses 31 through 32, where the security key is a PTK that includes a KCK and a TK.
Clause 34: The AMP wireless device of clause 33, where at least an information portion the first operational message is encrypted using the PTK, and where the processing system is further configured to cause the AMP wireless device to: decrypt the first operational message using the PTK; and transmitting an operational response message in accordance with an indication in the first operational message.
Clause 35: The AMP wireless device of clause 34, where the first operational message further includes a message integrity check portion that includes a first integrity check that is generated using the information portion and the KCK.
Clause 36: The AMP wireless device of clause 33, where the first operational message is unencrypted and includes an information portion and a message integrity check portion that includes a first integrity check that is generated using the information portion and the KCK, and where the processing system is further configured to cause the AMP wireless device to: transmit an operational response message in accordance with the information portion when a second integrity check computed at the AMP wireless device matches the first integrity check; and discard the first operational message when the second integrity check is different than the first integrity check.
Clause 37: The AMP wireless device of any of clauses 31 through 36, where the first operational message is an operation mode request message, and where the processing system is further configured to cause the AMP wireless device to: transmit, in response to the operation mode request message, an operation mode response message that provides operational details associated with the AMP wireless device.
Clause 38: The AMP wireless device of any of clauses 31 through 33, where the key generation request further indicates an operation mode request for operational details associated with the AMP wireless device, and the response message indicates the second random number, the integrity check, and an operation mode response that provides the operational details associated with the AMP wireless device.
Clause 39: The AMP wireless device of any of clauses 31 through 37, where the processing system is further configured to cause the AMP wireless device to: receive, subsequent to transmitting the response message and prior to receiving the first operational message, a key confirmation message that indicates that the security key is synchronized between the AMP wireless device and an associated access point.
Clause 40: The AMP wireless device of any of clauses 31 through 39, where the first operational message is a trigger message, and where the processing system is further configured to cause the AMP wireless device to: transmit a trigger response with a data payload associated with the trigger message, where the trigger response is secured using the security key.
Clause 41: The AMP wireless device of any of clauses 31 through 33, where the key generation request further includes a trigger message for the AMP wireless device, and the response message indicates the second random number, the integrity check, and includes a data payload associated with the trigger message.
Clause 42: The AMP wireless device of any of clauses 31 through 41, where the key generation request is received from an AMP AP that provides an energizing signal to the AMP wireless device, and the response message is transmitted to a non-AMP AP that is different from the AMP AP.
Clause 43: The AMP wireless device of any of clauses 31 through 41, where the AMP wireless device is co-located with a non-AMP wireless device, and where the processing system is further configured to cause the AMP wireless device to: receive, from a non-AMP AP, at least the master key; storing the security key and the master key in a persistent memory associated with the AMP wireless device; and communicate with one or more of the non-AMP wireless device or the non-AMP AP in accordance with the stored security key and master key, where the stored security key and master key are associated with multiple different energizing signals associated with supplying power to one or more components of the AMP wireless device.
Clause 44: The AMP wireless device of any of clauses 31 through 43, where a set of multiple of messages are received at the AMP wireless device from an interrogating device, the set of multiple of messages unassociated with subsequent operational messages, and the AMP wireless device discontinues transmitting response messages to the interrogating device.
Clause 45: The AMP wireless device of any of clauses 31 through 36, where the first operational message is a trigger message, and where the processing system is further configured to cause the AMP wireless device to: receive a set of multiple of trigger messages within a time period; transmit a set of multiple of trigger response messages associated with the set of multiple of trigger messages; and discontinue transmission of trigger response messages when a quantity of trigger messages within the time period exceeds a threshold value.
Clause 46: The AMP wireless device of any of clauses 31 through 36, where the first operational message is a trigger message, and where the processing system is further configured to cause the AMP wireless device to: receive a set of multiple of trigger messages; and transmit a trigger response message to one or more randomly selected trigger messages of the set of multiple of trigger messages.
Clause 47: The AMP wireless device of any of clauses 31 through 46, where the processing system is further configured to cause the AMP wireless device to: receive a second operational message that indicates one or more prior response messages were not received at an associated AP; and transmitting a response that indicates that the AMP wireless device was unable to transmit the one or more prior response messages, or that the one or more prior response messages were transmitted by the AMP wireless device.
Clause 48: An AP including: a processing system that includes processor circuitry and memory circuitry that stores code, the processing system configured to cause the AP to: transmit an energizing signal to an AMP wireless device for supplying power to one or more components of the AMP wireless device; transmit a key generation request to the AMP wireless device that includes a first random number; and receive, from the AMP wireless device, a response message indicating a second random number and an integrity check, where the second random number is different from the first random number, and the second random number, the integrity check, or both are secured in accordance with a security key that is associated with the first random number, the second random number, and a master security key.
Clause 49: The AP of clause 48, where the processing system is further configured to cause the AP to: transmit, to the AMP wireless device, at least a first operational message associated with a first data communication of the AMP wireless device, where the first operational message, a payload associated with the first operational message, or both, are secured using the security key.
Clause 50: The AP of any of clauses 48 through 49, where the processing system is further configured to cause the AP to: generate the security key in accordance with the first random number, the second random number, and the master key, where the security key is specific to the key generation request.
Clause 51: The AP of any of clauses 48 through 50, where the security key is a PTK that includes a KCK and a TK.
Clause 52: The AP of clause 51, where the processing system is further configured to cause the AP to: encrypt at least an information portion of a first operational message using the PTK; transmit the encrypted first operational message to the AMP wireless device; and receive an operational response message from the AMP wireless device in accordance with an indication in the first operational message, where the operational response message is encrypted using the PTK.
Clause 53: The AP of clause 52, where the first operational message further includes a message integrity check portion that includes a first integrity check that is generated using the information portion and the KCK.
Clause 54: The AP of clause 51, where the processing system is further configured to cause the AP to: transmit a first operational message, including an information portion and a message integrity check that is generated using the information portion and the KCK, to the AMP wireless device, where the first operational message is unencrypted.
Clause 55: The AP of any of clauses 48 through 54, where the processing system is further configured to cause the AP to: transmit an operation mode request message to the AMP wireless device, where the operation mode request message, a payload associated with the operation mode request message, or both, are secured using the security key; and receive, in response to the operation mode request message, an operation mode response message that provides operational details associated with the AMP wireless device, where the operation mode response message, a payload associated with the operation mode response message, or both, are secured using the security key.
Clause 56: The AP of any of clauses 48 through 55, where the key generation request further indicates an operation mode request for operational details associated with the AMP wireless device, and the response message indicates the second random number, the integrity check, and an operation mode response that provides the operational details associated with the AMP wireless device.
Clause 57: The AP of any of clauses 48 through 56, where the processing system is further configured to cause the AP to: transmit, subsequent to receiving the response message and prior to transmitting a first operational message, a key confirmation message that indicates that the security key is synchronized between the AMP wireless device and the AP.
Clause 58: The AP of any of clauses 48 through 57 where the processing system is further configured to cause the AP to: transmit a trigger message to the AMP wireless device, where the trigger message, a payload associated with the trigger message, or both, are secured using the security key; and receive a trigger response with a data payload associated with the trigger message, where the trigger response, the payload, or both, are secured using the security key.
Clause 59: The AP of any of clauses 48 through 55, where the key generation request further includes a trigger message for the AMP wireless device, and the response message indicates the second random number, the integrity check, and includes a data payload associated with the trigger message.
Clause 60: The AP of any of clauses 48 through 59, where the processing system is further configured to cause the AP to: transmit a set of multiple of operational messages to the AMP wireless device; transmit, in response to one or more response messages associated with the set of multiple of operational message being undetected at the AP, a second operational message to the AMP wireless device that indicates the one or more response messages were not received at the AP; receive a response from the AMP wireless device that indicates the one or more response messages were transmitted by the AMP wireless device; and modify one or more of a start time or a duration of an energizing signal associated with one or more operational messages.
Clause 61: An AMP wireless device for wireless communications, including at least one means for performing a method of any of clauses 1 through 17.
Clause 62: A non-transitory computer-readable medium storing code for wireless communications, the code including instructions executable by a processing system to perform a method of any of clauses 1 through 17.
Clause 63: An AP for wireless communications, including at least one means for performing a method of any of clauses 18 through 30.
Clause 64: A non-transitory computer-readable medium storing code for wireless communications, the code including instructions executable by a processing system to perform a method of any of clauses 18 through 30.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An ambient power (AMP) wireless device, comprising:
a processing system that includes processor circuitry and memory circuitry that stores code, the processing system configured to cause the AMP wireless device to:
receive an energizing signal associated with supplying power to one or more components of the AMP wireless device;
receive a key generation request that includes a first random number associated with generating a security key;
transmit, in accordance with the power supplied to the one or more components of the AMP wireless device, a response message indicating a second random number and an integrity check, wherein the integrity check is associated with the security key, the second random number, and a master key; and
receive at least a first operational message associated with a first data communication from the AMP wireless device, wherein the first operational message, a payload associated with the first operational message, or both, are secured using the security key.

2. The ambient power (AMP) wireless device of claim 1, wherein the processing system is further configured to cause the AMP wireless device to:
generate the second random number in response to the key generation request, wherein the security key is specific to the received key generation request.

3. The AMP wireless device of claim 1, wherein the security key is a pairwise transient key (PTK) that includes a key confirmation key (KCK) and a temporal key (TK).

4. The AMP wireless device of claim 3, wherein at least an information portion the first operational message is encrypted using the PTK, and the processing system is further configured to cause the AMP wireless device to:
decrypt the first operational message using the PTK; and
transmit an operational response message in accordance with an indication in the first operational message.

5. The AMP wireless device of claim 4, wherein the first operational message further includes a message integrity check portion that includes a first integrity check that is generated using the information portion and the KCK.

6. The AMP wireless device of claim 3, wherein the first operational message is unencrypted and includes an information portion and a message integrity check portion that includes a first integrity check that is generated using the information portion and the KCK, and the processing system is further configured to cause the AMP wireless device to:
transmit an operational response message in accordance with the information portion when a second integrity check computed at the AMP wireless device matches the first integrity check; and
discard the first operational message when the second integrity check is different than the first integrity check.

7. The AMP wireless device of claim 1, wherein the first operational message is an operation mode request message, and the processing system is further configured to cause the AMP wireless device to:
transmit, in response to the operation mode request message, an operation mode response message that provides operational details associated with the AMP wireless device.

8. The AMP wireless device of claim 1, wherein:
the key generation request further indicates an operation mode request for operational details associated with the AMP wireless device, and
the response message indicates the second random number, the integrity check, and an operation mode response that provides the operational details associated with the AMP wireless device.

9. The AMP wireless device of claim 1, wherein the processing system is further configured to cause the AMP wireless device to:
receive, subsequent to transmitting the response message and prior to receiving the first operational message, a key confirmation message that indicates that the security key is synchronized between the AMP wireless device and an associated access point.

10. The AMP wireless device of claim 1, wherein the first operational message is a trigger message, and the processing system is further configured to cause the AMP wireless device to:
transmit a trigger response with a data payload associated with the trigger message, wherein the trigger response is secured using the security key.

11.-12. (canceled)

13. The AMP wireless device of claim 1, wherein the AMP wireless device is co-located with a non-AMP wireless device, and the processing system is further configured to cause the AMP wireless device to:
receive, from a non-AMP access point (AP), at least the master key;
store the security key and the master key in a persistent memory associated with the AMP wireless device; and
communicate with one or more of the non-AMP wireless device or the non-AMP AP in accordance with the stored security key and master key, wherein the stored security key and master key are associated with multiple different energizing signals associated with supplying power to one or more components of the AMP wireless device.

14. The AMP wireless device of claim 1, wherein a plurality of messages are received at the AMP wireless device from an interrogating device, the plurality of messages unassociated with subsequent operational messages, and the AMP wireless device discontinues transmitting response messages to the interrogating device.

15. The AMP wireless device of claim 1, wherein the first operational message is a trigger message, and the processing system is further configured to cause the AMP wireless device to:
receive a plurality of trigger messages within a time period;
transmit a plurality of trigger response messages associated with the plurality of trigger messages; and
discontinue transmission of trigger response messages when a quantity of trigger messages within the time period exceeds a threshold value.

16. The AMP wireless device of claim 1, wherein the first operational message is a trigger message, and the processing system is further configured to cause the AMP wireless device to:
receive a plurality of trigger messages; and
transmit a trigger response message to one or more randomly selected trigger messages of the plurality of trigger messages.

17. The AMP wireless device of claim 1, wherein the processing system is further configured to cause the AMP wireless device to:
receive a second operational message that indicates one or more prior response messages were not received at an associated access point (AP); and
transmit a response that indicates that the AMP wireless device was unable to transmit the one or more prior response messages, or that the one or more prior response messages were transmitted by the AMP wireless device.

18. An access point (AP), comprising:
a processing system that includes processor circuitry and memory circuitry that stores code, the processing system configured to cause the AP to:
transmit an energizing signal to an ambient power (AMP) wireless device for supplying power to one or more components of the AMP wireless device;
transmit a key generation request to the AMP wireless device that includes a first random number; and
receive, from the AMP wireless device, a response message indicating a second random number and an integrity check, wherein the second random number is different from the first random number, and the second random number, the integrity check, or both are secured in accordance with a security key that is associated with the first random number, the second random number, and a master security key.

19. The AP of claim 18, wherein the processing system is further configured to cause the AP to:
transmit, to the AMP wireless device, at least a first operational message associated with a first data communication of the AMP wireless device, wherein the first operational message, a payload associated with the first operational message, or both, are secured using the security key.

20.-21. (canceled)

22. The AP of claim 18, wherein the security key is a pairwise transient key (PTK), and the processing system is further configured to cause the AP to:
encrypt at least an information portion of a first operational message using the PTK;
transmit the encrypted first operational message to the AMP wireless device; and
receive an operational response message from the AMP wireless device in accordance with an indication in the first operational message, wherein the operational response message is encrypted using the PTK.

23.-24. (canceled)

25. The AP of claim 18, wherein the processing system is further configured to cause the AP to:
transmit an operation mode request message to the AMP wireless device, wherein the operation mode request message, a payload associated with the operation mode request message, or both, are secured using the security key; and
receive, in response to the operation mode request message, an operation mode response message that provides operational details associated with the AMP wireless device, wherein the operation mode response message, a payload associated with the operation mode response message, or both, are secured using the security key.

26.-29. (canceled)

30. The AP of claim 18, wherein the processing system is further configured to cause the AP to:
transmit a plurality of operational messages to the AMP wireless device;
transmit, in response to one or more response messages associated with the plurality of operational message being undetected at the AP, a second operational message to the AMP wireless device that indicates the one or more response messages were not received at the AP;
receive, from the AMP wireless device, an indication that the one or more response messages were transmitted by the AMP wireless device; and
modify one or more of a start time or a duration of the energizing signal associated with one or more operational messages.

31. A method for wireless communications at an ambient power (AMP) wireless device, comprising:
receiving an energizing signal associated with supplying power to one or more components of the AMP wireless device;
receiving a key generation request that includes a first random number associated with generating a security key;
transmitting, in accordance with the power supplied to the one or more components of the AMP wireless device, a response message indicating a second random number and an integrity check, wherein the integrity check is associated with the security key, the second random number, and a master key; and
receiving at least a first operational message associated with a first data communication from the AMP wireless device, wherein the first operational message, a payload associated with the first operational message, or both, are secured using the security key.

32. The method of claim 31, further comprising:
generating the second random number in response to the key generation request, wherein the security key is specific to the received key generation request.

33.-36. (canceled)

37. The method of claim 31, wherein the first operational message is an operation mode request message, and wherein the method further comprises:
transmitting, in response to the operation mode request message, an operation mode response message that provides operational details associated with the AMP wireless device.

38.-40. (canceled)

41. The method of claim 31, wherein:
the key generation request further includes a trigger message for the AMP wireless device, and
the response message indicates the second random number, the integrity check, and includes a data payload associated with the trigger message.

42.-43. (canceled)

44. The method of claim 31, wherein a plurality of messages are received at the AMP wireless device from an interrogating device, the plurality of messages unassociated with subsequent operational messages, and the AMP wireless device discontinues transmitting response messages to the interrogating device.

45.-47. (canceled)

48. A method for wireless communications at an access point (AP), comprising:
transmitting an energizing signal to an ambient power (AMP) wireless device for supplying power to one or more components of the AMP wireless device;
transmitting a key generation request to the AMP wireless device that includes a first random number; and
receiving, from the AMP wireless device, a response message indicating a second random number and an integrity check, wherein the second random number is different from the first random number, and the second random number, the integrity check, or both are secured in accordance with a security key that is associated with the first random number, the second random number, and a master security key.

49. The method of claim 48, further comprising:
transmitting, to the AMP wireless device, at least a first operational message associated with a first data communication of the AMP wireless device, wherein the first operational message, a payload associated with the first operational message, or both, are secured using the security key.

50. The method of claim 48, further comprising:
generating the security key in accordance with the first random number, the second random number, and the master key, wherein the security key is specific to the key generation request.

51.-54. (canceled)

55. The method of claim 48, further comprising:
transmitting an operation mode request message to the AMP wireless device, wherein the operation mode request message, a payload associated with the operation mode request message, or both, are secured using the security key; and
receiving, in response to the operation mode request message, an operation mode response message that provides operational details associated with the AMP wireless device, wherein the operation mode response message, a payload associated with the operation mode response message, or both, are secured using the security key.

56.-59. (canceled)

60. The method of claim 48, further comprising:
transmitting a plurality of operational messages to the AMP wireless device;
transmitting, in response to one or more response messages associated with the plurality of operational message being undetected at the AP, a second operational message to the AMP wireless device that indicates the one or more response messages were not received at the AP;
receiving, from the AMP wireless device, an indication that the one or more response messages were transmitted by the AMP wireless device; and
modifying one or more of a start time or a duration of the energizing signal associated with one or more operational messages.
